(19) United States
(12) Patent Application Publication
(10) Pub. No.: US 2014/0164289 A1
(43) Pub. Date: Jun. 12, 2014

(54) DUE DILIGENCE AND DISCLOSURE REPORT CREATION AND PRESENTATION SYSTEM, AND COMPUTER READABLE MEDIUM

(71) Applicant: CrowdCheck Inc., Alexandria, VA (US)

(72) Inventors: Sara P. Hanks, Alexandria, VA (US); Brian Knight, FallsChurch, VA (US); Thaya Knight, FallsChurch, VA (US); Huiwen Leo, Kaneohe, HI (US)

(73) Assignee: CrowdCheck Inc., Alexandria, VA (US)

(21) Appl. No.: 14/070,044

(22) Filed: Nov. 1, 2013

Related U.S. Application Data
(60) Provisional application No. 61/785,376, filed on Mar. 14, 2013.
(60) Provisional application No. 61/721,324, filed on Nov. 1, 2012.

(51) Int. Cl. G06Q 40/06

(52) U.S. Cl. CPC G06Q 40/06
USPC 705/36 R

(57) ABSTRACT

Systems, methods, and processes are described that facilitate the production, transmission, analysis, and sharing of information. The disclosed subject matter allows a provider to create meaningful due diligence and disclosure reports on companies seeking to raise money from individuals via the Internet and other communications mediums and present this information in an easily accessibly manner integrated within various mediums, including but not limited to the websites of platforms who serve as intermediaries between the company seeking investment and the potential investing public.

### CROSS REFERENCE TO RELATED APPLICATIONS

This application claims priority to U.S. Provisional Patent Application Ser. No. 61/785,376 entitled “DUE DILIGENCE AND DISCLOSURE REPORT CREATION AND PRESENTATION SYSTEM, AND COMPUTER READABLE MEDIUM”, filed Mar. 14, 2013, and to U.S. Provisional Patent Application Ser. No. 61/721,324 entitled “DUE DILIGENCE AND DISCLOSURE REPORT CREATION AND PRESENTATION SYSTEM, AND COMPUTER READABLE MEDIUM”, filed Nov. 1, 2012, each of which is hereby incorporated herein by reference in its entirety

### FIELD OF THE INVENTION

This disclosure relates generally to business processes and electronic communications and more specifically to due diligence and disclosure services performed in the context of companies seeking investment via communications with investors via intermediary platforms using an electronic medium.

### BACKGROUND

As companies (“companies” or “CO”) seek to grow they frequently seek investment from individuals or entities (“investors”). For much of the 20^{th} century the ability of small companies and the general public to participate in investment has been limited. While companies who have listed on a public stock exchange via an initial public offering can seek direct investment from the general public, small companies' ability to solicit the public directly was limited to either friends and family with intimate knowledge of the business or “accredited investors”—high net worth individuals presumed to be more sophisticated and able to better sustain the loss of the money they invested in the company if the company failed. Likewise, small investors were unable to invest in small or early stage companies, with the best opportunities to profit from early investment reserved for the wealthy and institutional investors—companies such as banks, mutual funds, and venture capital firms who use their resources to make investments in growing companies. However, in 2012 the law was changed by the Jumpstart Our Business Startups (JOBS) Act to allow smaller companies to solicit investment directly from the general public and to allow the general public to invest limited sums of money in smaller companies via an online intermediary (“platform” or “funding platform”). Currently these platforms include but are not necessarily limited to broker-dealers and crowdfunding portals. Platforms serve as an intermediary between companies and investors where companies can provide promotional and factual information for investors to review and investors can invest in the companies they like. The platforms manage the transaction and either hire a third party to perform necessary clearance and settlement functions or perform the functions themselves.

One essential function is providing due diligence and disclosure services that give investors information about the health and status of the company, and protection against the possibility that the company soliciting investment is a fraud. Traditionally, to the extent due diligence has been performed it has followed one of two models. The first model, common in initial public offerings and investment deals with institutional investors, involves the company or the investor performing an expensive and exhaustive due diligence procedure. This often involves large numbers of lawyers and accountants, and can cost well in excess of a million dollars. The product created by this level of diligence is usually a dense and voluminous document provided on a limited basis to the underwriters of the IPO exclusively. The investor generally does not have access to the underlying evidence or the work-product created by the lawyers or accountants and has to rely on the reputation of the underwriter and the law and/or accounting firm that performed the due diligence. The second model, common in donation-based crowdfunding, is a public-driven model where intermediaries rely on public comment to provide feedback on companies and highlight problems or red flags.

Both of these methods have serious problems as applied to the securities-based crowdfunding space for both entrepreneurs and investors. The initial public offering model is overly cumbersome and expensive for an industry where raises are limited to relatively small amounts of money. The costs of performing IPO-style diligence could easily consume so much money as to defeat the purpose of the raise, and the level of intrusion—which can be sustained by larger companies who can dedicate staff to the diligence process—cannot be sustained by smaller companies whose employees are fully committed to keeping the business running. Likewise, the crowdfunding investor is poorly served by this model on both the industry-wide and per-deal level: at the industry level, the problems with the system will prevent companies from entering the crowdfunding market, limiting the selection and quality of investment options; at the per-deal level, because the IPO model fails to provide the investor access to the underlying data and evidence in a readily accessible medium, the model prevents investors from having the information necessary to allow them to make their own decisions.

The public-driven model is also flawed. By relying on comments, often anonymous, from the general public, the public-driven model is severely limited in terms of reliability and access to information. The public-driven model rests on public commenters discussing the legitimacy and viability of a company or project and therefore relies on the commenters' honesty and accuracy. These assumptions are often inaccurate since Internet commenting is often subject to fraudulent information being provided by people who have ulterior motives. Even if the comments are honest the public generally does not have access to sufficient essential information on the company to provide meaningful insight to constitute due diligence.

In view of the above limitations, there is a need for a new method of providing efficient and accessible due diligence for Internet-based investment opportunities.

### SUMMARY

The disclosed subject matter solves these and other flaws.

It is a technical advantage of the disclosed subject matter to provide due diligence in a cost effective and easily accessible manner.

It is a technical advantage of the disclosed subject matter to provide due diligence content to platforms in a manner that allows for near real-time transmission and integration into the platform's workflow.

It is a technical advantage of the disclosed subject matter to allow end-user investors to access easily intelligible and robust due diligence reports via the Internet and other electronic media.

It is a technical advantage to allow end-user investors to access all supporting documentation and explanatory material instantly via hyperlink or other means within the report.

One or more embodiments may include a method for performing due diligence disclosure services, the method comprising: receiving initial contact and identifying information from an entity about a company seeking investment; transmitting core information derived from the initial contact and identifying information to a provider; receiving results of due diligence on the company performed by the provider using the core information; preparing a report based on results of performing due diligence; and providing the report to a computing device.

One or more embodiments may include a system for performing due diligence disclosure services, the system comprising: a memory; and a processor in communication with the memory, wherein the processor is configured to: receive initial contact and identifying information from an entity about a company seeking investment; transmit core information derived from the initial contact and identifying information to a provider; receive results of due diligence on the company performed by the provider using the core information; prepare a report based on results of performing due diligence; and provide the report to a computing device.

One or more embodiments may include a computer readable storage medium for performing due diligence disclosure services, the computer readable storage medium comprising instructions that if executed enables a computing system to: receive initial contact and identifying information from an entity about a company seeking investment; transmit core information derived from the initial contact and identifying information to a provider; receive results of due diligence on the company performed by the provider using the core information; prepare a report based on results of performing due diligence; and provide the report to a computing device.

In one or more embodiments, receiving results of due diligence on the company performed by the provider using the core information indicates that the company satisfies proprietary criteria of the provider. In one or more embodiments, the proprietary criteria of the provider comprises information necessary for the provider to determine that the company is, with regard to a scope of a review, compliant with legal requirements of seeking an investment and accurate in the company's disclosures.

In one or more embodiments, the report is free of technical defects and material defects. In one or more embodiments, technical defects comprise at least one of a missing document, an outdated document, that a needed permit is available but not yet obtained, a failure to perform needed corporate governance to authorize raising of investment, or a failure to remain in good standing with the company's state of incorporation for a reason that can be remediated. In one or more embodiments, material defects comprise at least one of evidence of fraud, statutory disqualification, regulatory disqualification, or a defect that is unfixable and legally fatal to the company's ability to pursue a desired activity.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features, and advantages here provided will become apparent to one with skill in the art upon examination of the following FIGUREs and detailed description. It is intended that all such additional systems, methods, features and advantages that are included within this description be within the scope of any claims filed later.

### BRIEF DESCRIPTION OF THE DRAWINGS

FIG. 1 is a flow diagram 100 detailing the disclosed subject matter's initial process of obtaining information from issuing companies or platform.

FIG. 2 is a flow diagram 200 detailing the disclosed subject matter's workflow for processing a company's due diligence report.

FIG. 3 is a flow diagram 300 detailing the disclosed subject matter's workflow for processing any documents or supporting evidence relevant to a due diligence report.

FIG. 4 is a flow diagram 400 detailing the disclosed subject matter's workflow for the post-raise review of a company.

FIG. 5 is a visual representation 500 of a particular embodiment of the interface used by the public to receive information from the disclosed subject matter.

FIG. 6 depicts an exemplary architecture for implementing a computing device in accordance with one or more embodiments.

FIG. 7 depicts a schematic block diagram of an exemplary system in accordance with one or more embodiments.

FIG. 8 is a visual representation of an alternative embodiment of the interface used by the public to receive information from the disclosed subject matter.

FIG. 9 is a visual representation of an alternative embodiment of the interface used by the public to receive information from the disclosed subject matter.

FIG. 10 is a visual representation of an alternative embodiment of the interface used by the public to receive information from the disclosed subject matter.

FIGS. 11A-11B depict a visual representation of an alternative embodiment of the interface used by the public to receive information from the disclosed subject matter.

FIGS. 12A-12N depict a visual representation of an alternative embodiment of the interface used by the public to receive information from the disclosed subject matter.

FIGS. 13A-13B depict a visual representation of an alternative embodiment of the interface used by the public to receive information from the disclosed subject matter.

FIGS. 14A-14M depict a visual representation of an alternative embodiment of the interface used by the public to receive information from the disclosed subject matter.

FIGS. 15A-15J depict exemplary information, document request and release forms for receiving information about a company.

FIGS. 16A-16G depict exemplary affirmations, verifications, and release forms for receiving information about a company.

### DETAILED DESCRIPTION OF THE DRAWINGS

Although described with particular reference to certain industries and/or equipment, those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

The term Company shall include but not be limited to all companies or other entities that solicit money from the public or some sub-set thereof, corporations, institutional investors such as venture capital firms and banks, or other entities that invest money. The term Investors shall include all public, private, individual, or institutional parties that provide money to companies or other entities. The term Platform shall include but not be limited to Crowdfunding Platforms, Broker/Dealers, and other entities that can serve as intermediaries between companies and investors. The term Report shall include but not be limited to any document in any medium including but not limited to written, audio, or visual, and video, that conveys information. The disclosed subject matter is anticipated to be used by a due diligence provider, such as CROWDCHECK®, but could be used by other entities under appropriate agreements. Several figures include the marking “CC”, which may refer to any platform or provider.

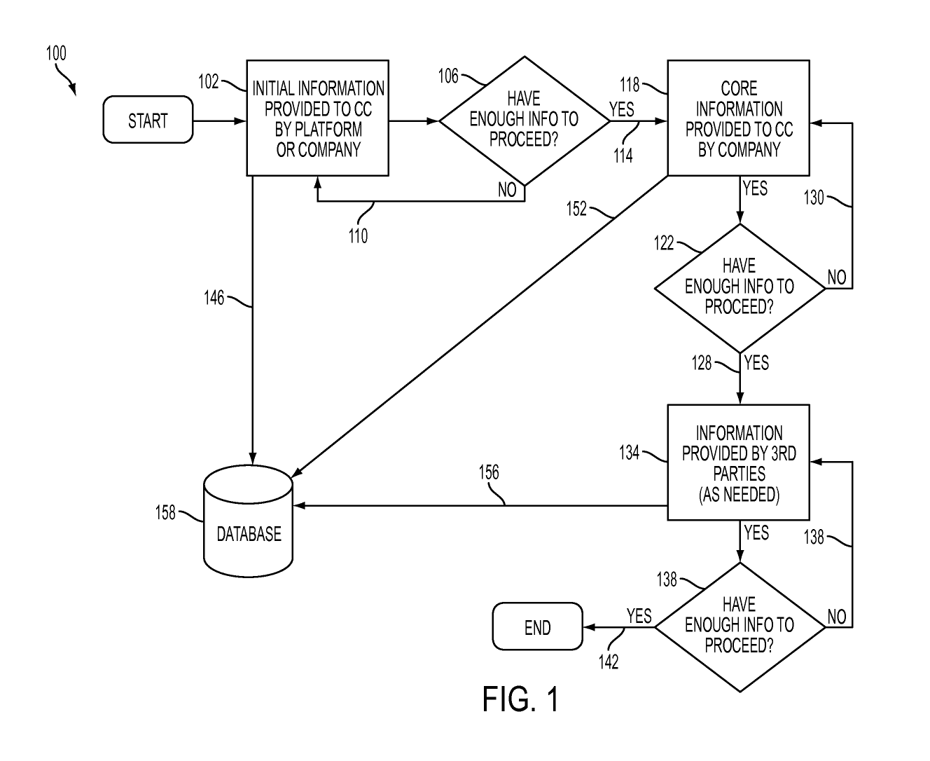

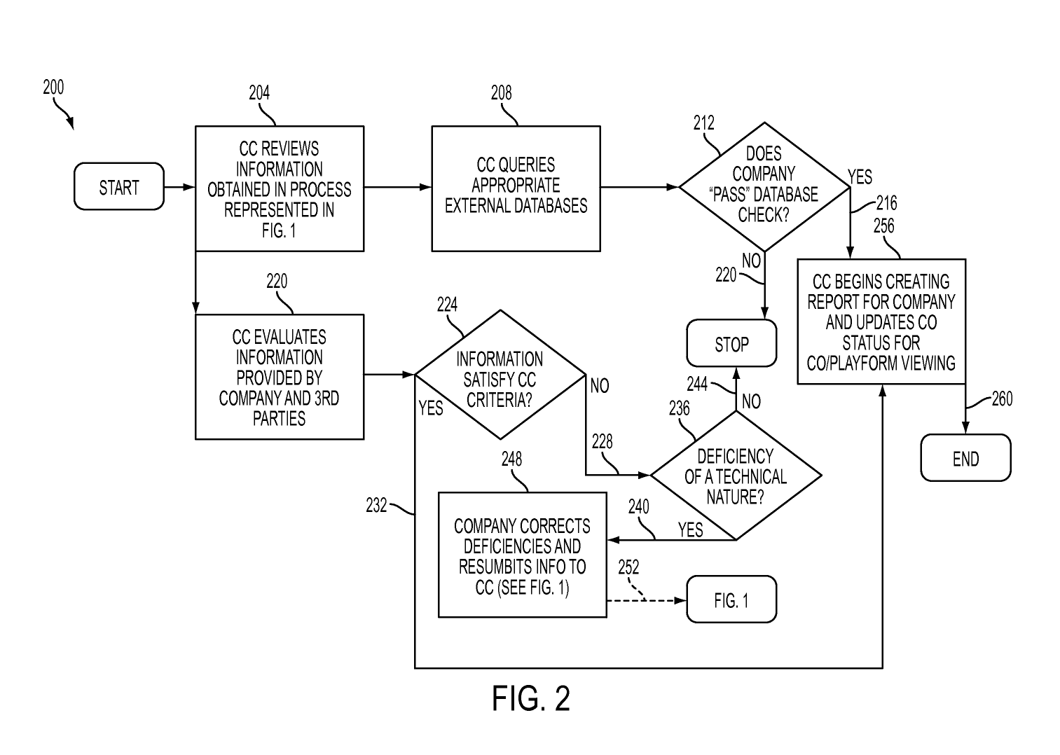

FIG. 1 is a visual representation of a system 100 where the disclosed subject matter receives and stores information from a company seeking investment or a platform that will serve as the intermediary for the company seeking investment. The company and/or platform in question provides initial contact and identifying information, such as company name and contact information to a due diligence provider (provider) via methods including but not limited to telephone, fax, email, and direct uploading via file transfer protocol 102, this information will be stored in the provider's database 158. At this point provider will need to determine if the information it has been provided is sufficiently fulsome to proceed 106. Sufficiently fulsome may refer to enough information to identify the specific company (e.g. Joe's plumbing in Utica vs. Joe's plumbing in Salt Lake), the appropriate contact and control person that the provider would need to talk to, and, if available, the expected use of the product (e.g. will it be on a specific platform, if so which, or will it be used by the company on its own website). The criteria for making the determination of whether the information is sufficiently fulsome to proceed may be objective identifying information (e.g. name, address, phone etc.) of the company, and may include what platform is referring the company. The provider may make this determination.

If the information provided is sufficient 114 than the company will provide provider with the core information necessary to pursue a due diligence 118, if not 110 provider will request more contact and identifying information. Once the company has provided the core information, provider will assess whether the information provided is complete 122; if it is 128, provider will assess 134 whether any third-party information is required based on the level of check required and the information provided by the company and/or platform. The different levels of check may contain different criteria that is analyzed. The lowest level may consider fewer aspects of the company's structure, business, operations, and pitch materials than the higher levels, because such information may not be relevant at the lower levels of the check. However, a provider may ask for the information required for higher level checks even when performing lower level checks in some cases, such as when it is expected that the company will upgrade from a lower level of check to a higher one. If the information provided by the company is not complete 130, the provider will solicit additional information for the company. The core information 118 will be stored 152 in the provider database 158. If any third-party information is required, provider will solicit it 134 and assess whether the information is sufficient 136. If not, additional information will be solicited. If the information is sufficient, provider can move 142 on to the next step in the due diligence process FIG. 2, and any necessary third-party information may be stored 156 in the provider database 158.

FIG. 2 is a visual representation of a system 200 in which the disclosed subject matter performs due diligence for the company. Provider will review 204 the information obtained in the process represented in FIG. 1. Provider will then review the appropriate external databases 208 potentially including, but not limited to, criminal-background and securities regulatory databases, and evaluate the information obtained by the company and third-parties 222 in light of provider's proprietary criteria. If the reports on the company and relevant individuals are acceptable 216 and the information obtained satisfies provider's criteria (see 224) provider will begin creating the report for the company and update the company status for viewing by the company and/or platform via methods including but not limited to a limited access dashboard, application programming interface (API), or email 258, if the results are unacceptable 220 the due diligence process stops.

The provider's criteria may be set by regulation and/or the business rules of the hosting platform in cases where there is a hosting platform. This criteria may include the regulatory requirements (e.g. the SEC's new “bad actor” rules for certain raises), but may also include criteria established by a platform that is considering hosting the raise. For example, while an assault conviction is not disqualifying under the bad actor rules, a platform may have more stringent rules that exclude any criminal or any level of criminality. For example, if this check is done at the behest of or to the standard of more stringent rules and the issuer has an assault charge, the issuer would be rejected. The provider's criteria may comprise the information necessary for the provider to determine that the company is, with regard to the scope of the review, compliant with the legal requirements of seeking such investment and accurate in its disclosures. The proprietary criteria of the provider may comprise information necessary for the provider to determine that the company is, with regard to a scope of a review, compliant with legal requirements of seeking an investment and accurate in the company's disclosures

Provider will also evaluate the information obtained from the company and third parties 222, if the information satisfies provider's proprietary criteria and the results of the relevant background checks are acceptable (see 216), provider will begin creating the report 234, if not provider will determine whether the defect is of a technical or material nature 238. If the defect is technical (e.g. a document is missing or out of date, a needed permit is available but not yet obtained) provider will direct the company to correct the defect 242 and the company will resubmit the information 250 via the process represented in FIG. 1 (see 252). A technical defect may refer to a defect that is fixable and not the product of intentional bad dealing on the part of the company. An example would be failing to pay one's franchise tax. An example of a non-technical defect would be lying about how many factories one has available. Other examples of technical defects include a failure to perform needed corporate governance to authorize the raising of investment, or the failure to remain in good standing with their state of incorporation for a reason that can be remediated. Technical defects may comprise at least one of a missing document, an outdated document, that a needed permit is available but not yet obtained, a failure to perform needed corporate governance to authorize raising of investment, or a failure to remain in good standing with the company's state of incorporation for a reason that can be remediated. If the defect is material (e.g. evidence of fraud) the due diligence process will stop 246. A material defect may refer to a defect that is unfixable (e.g. the issuer is disqualified from using the particular exemption due to prior convictions) or the product of intentional bad acts by the issuer (e.g. lying about something as opposed to just being mistaken or having an inadvertent defect). Other examples of material defects include statutory or regulatory disqualification, such as under the “bad actor” rules, or a defect that is unfixable and legally fatal to the company's ability to pursue the desired activity. Material defects may comprise at least one of evidence of fraud, statutory disqualification, regulatory disqualification, or a defect that is unfixable and legally fatal to the company's ability to pursue a desired activity.

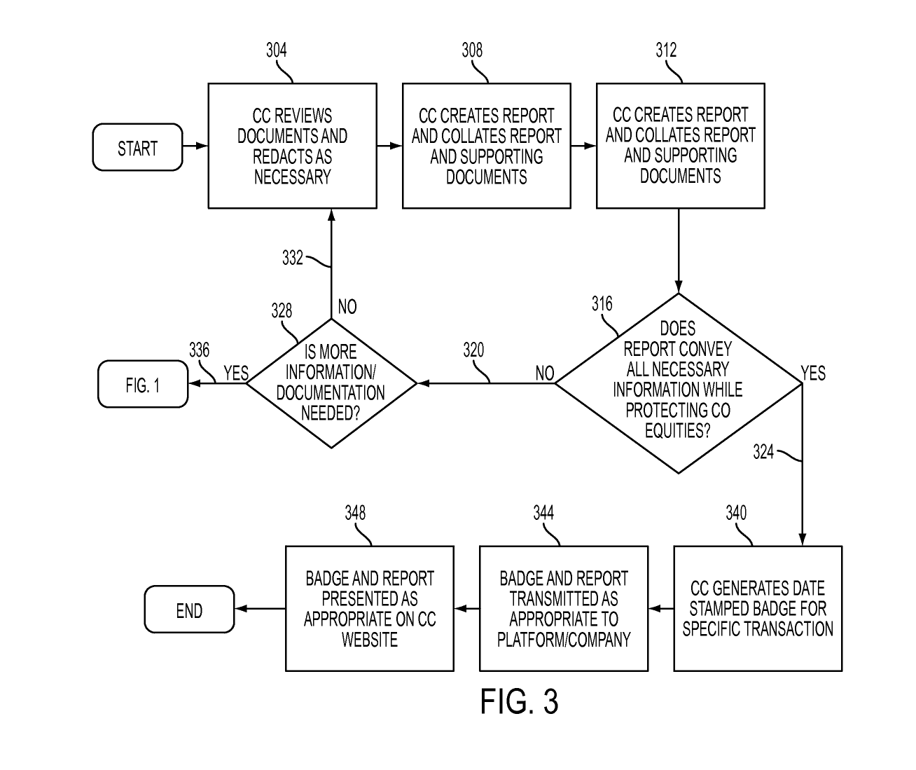

FIG. 3 is a visual representation of a system 300 in which the disclosed subject matter prepares and makes a report available to the public for viewing. Provider will review the documents obtained and redact the documents as necessary to protect sensitive information, consistent with provider's policies 304. After the review and redaction of the documents provider will create a report based on the relevant provider policies and the results of the information obtained 308, which is then collated with the relevant supporting documentation. The report is then reviewed 312 by provider staff and management to ensure quality and completeness, including but not limited to whether the report conveys all necessary information while protecting the sensitive information of the company to the extent possible 316. If the report does not (see 320), provider will determine if more information or documentation is needed 328, if so 336 provider will follow the process discussed in FIG. 1. If not 332 provider will return to the review and redaction phase 304. If the report is complete 324 provider will generate its collateral materials, including but not limited to a “badge” that provides a unique identifier for the particular transaction that the due diligence is being performed for 340. This “badge” will include a mix of information, including but not limited to text and visual cues that convey information on topics including but not limited to the time period the investment is taking place, the type of due diligence check conducted, the amount of money sought by the company, and the platform serving as the intermediary. This badge and report are then transmitted to the appropriate entity, including but not limited to the company itself, regulators, and/or a platform 344 via methods including but not limited to email, fax, API, or file upload. Once this report is transmitted it will be made available for public viewing on the web, TV, and any other media where such information is allowed under relevant law and regulation and interaction, possibly including but not limited to viewing, downloading, and sharing via methods such as but not limited to email and social networks 348. Though not portrayed on this figure the information shall be stored as appropriate by provider, in a method and via a medium that is appropriate under the relevant technological, legal, and business considerations.

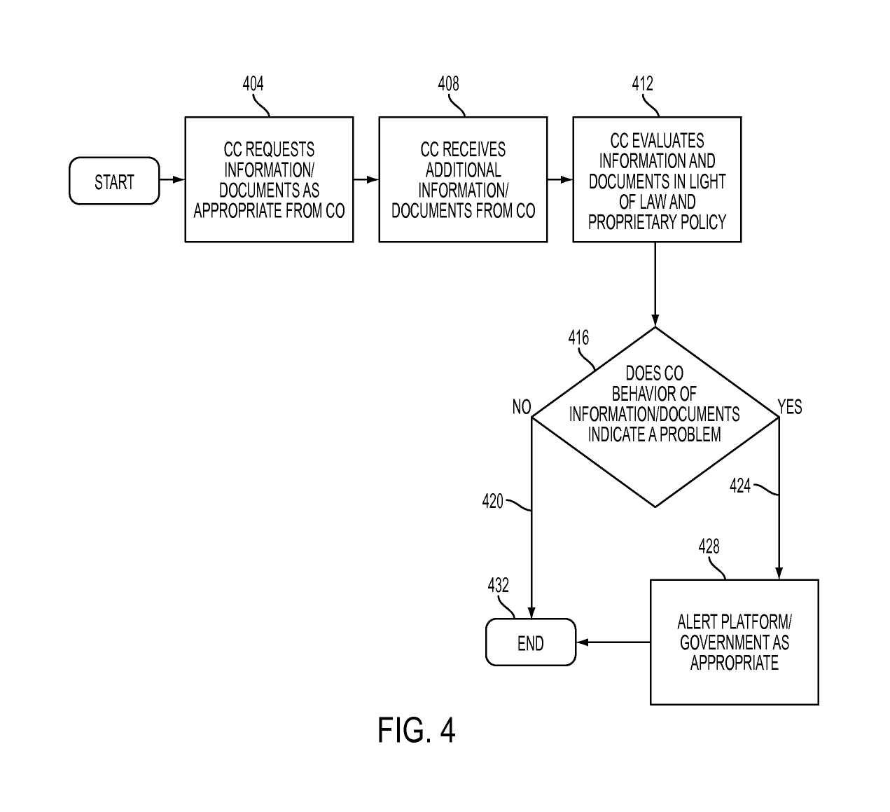

FIG. 4 is a representation of a system 400 where the disclosed subject matter performs a follow-up check on the company after it has raised money to ensure the money is being used for legitimate purposes. Provider will request information and supporting documentation, as appropriate from the Company 404. Once that information is received 408 provider will evaluate the information and documents in light of the relevant law, regulations, and provider's proprietary policy 412 to see if the information indicates a problem such as but not limited to the funds being obtained under false pretenses 416. If there is no indication of this 420 the process ends, if there is 424 provider may notify the platform, government, or other third parties as necessary 428.

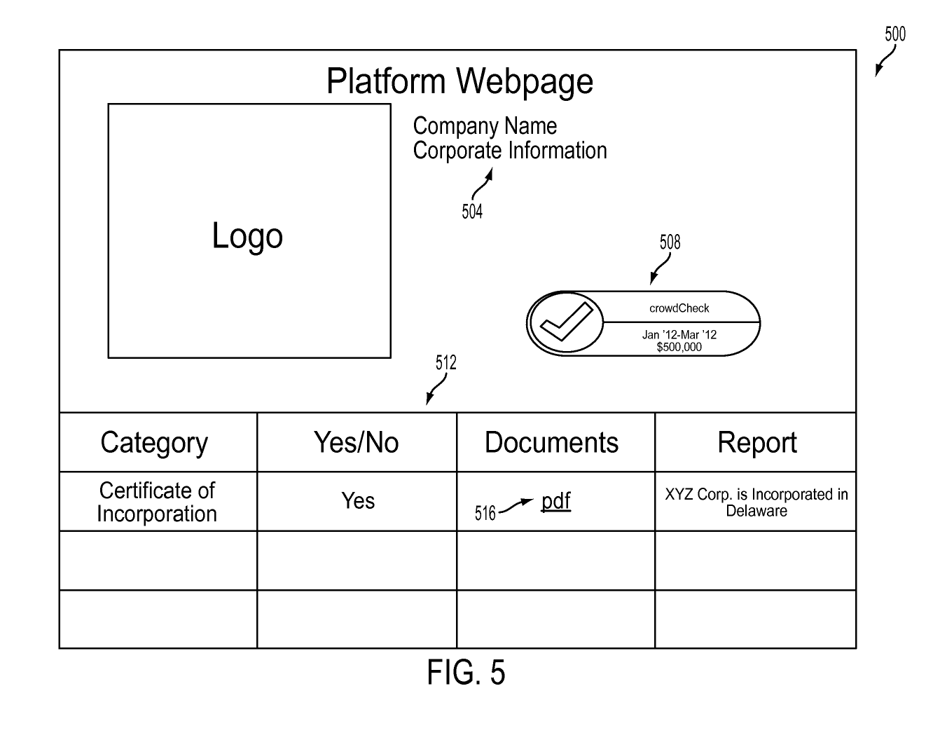

FIG. 5 is a visual representation of a particular embodiment of a graphical interface 500 of the disclosed subject matter presenting information on a platform's webpage. In this particular embodiment the report is 512 is integrated directly into the company's profile on the platform 504. Also displayed is a representation of the badge 508 used by the disclosed subject matter to quickly present information to the public. This representation also shows the ability to link to supporting documentation within the report 516.

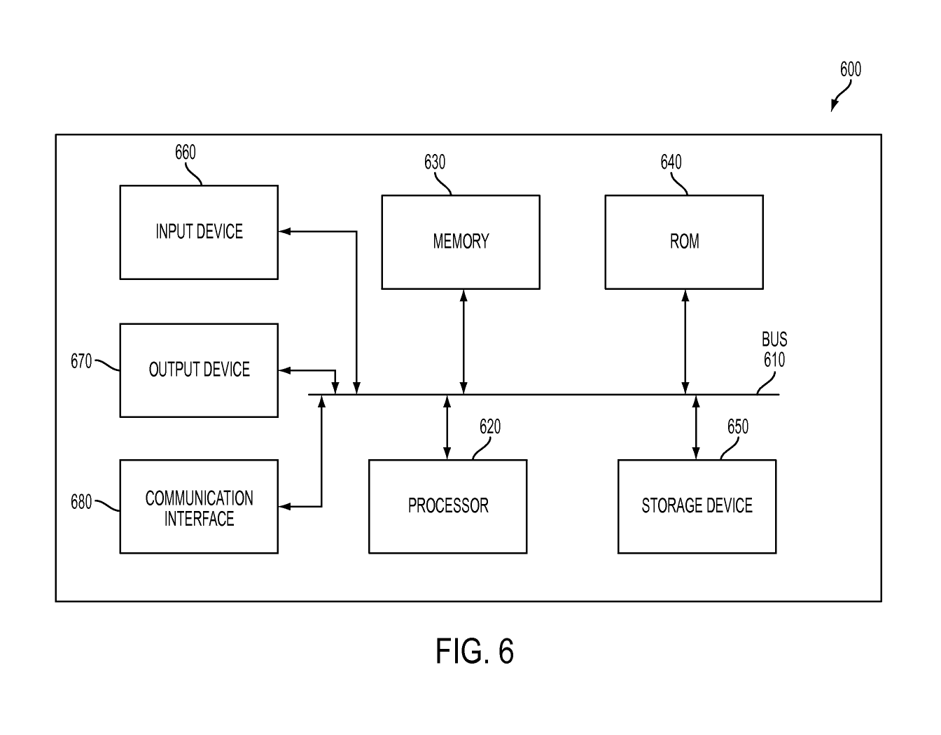

FIG. 6 depicts an exemplary architecture for implementing a computing device 600 in accordance with one or more embodiments. It will be appreciated that other devices that can be used with the computing device 600, such as a client or a server, may be similarly configured. As illustrated in FIG. 6, computing device 600 may include a bus 610, a processor 620, a memory 630, a read only memory (ROM) 640, a storage device 650, an input device 660, an output device 670, and a communication interface 680.

Bus 610 may include one or more interconnects that permit communication among the components of computing device 600. Processor 620 may include any type of processor, microprocessor, or processing logic that may interpret and execute instructions (e.g., a field programmable gate array (FPGA)). Processor 620 may include a single device (e.g., a single core) and/or a group of devices (e.g., multi-core). Memory 630 may include a random access memory (RAM) or another type of dynamic storage device that may store information and instructions for execution by processor 620. Memory 630 may also be used to store temporary variables or other intermediate information during execution of instructions by processor 620.

ROM 640 may include a ROM device and/or another type of static storage device that may store static information and instructions for processor 620. Storage device 650 may include a magnetic disk and/or optical disk and its corresponding drive for storing information and/or instructions. Storage device 650 may include a single storage device or multiple storage devices, such as multiple storage devices operating in parallel. Moreover, storage device 650 may reside locally on the computing device 600 and/or may be remote with respect to a server and connected thereto via network and/or another type of connection, such as a dedicated link or channel.

Input device 660 may include any mechanism or combination of mechanisms that permit an operator to input information to computing device 600, such as a keyboard, a mouse, a touch sensitive display device, a microphone, a pen-based pointing device, and/or a biometric input device, such as a voice recognition device and/or a finger print scanning device. Output device 670 may include any mechanism or combination of mechanisms that outputs information to the operator, including a display, a printer, a speaker, etc.

Communication interface 680 may include any transceiver-like mechanism that enables computing device 600 to communicate with other devices and/or systems, such as a client, a server, a license manager, a vendor, etc. For example, communication interface 680 may include one or more interfaces, such as a first interface coupled to a network and/or a second interface coupled to a license manager. Alternatively, communication interface 680 may include other mechanisms (e.g., a wireless interface) for communicating via a network, such as a wireless network. In one implementation, communication interface 680 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 600 may perform certain functions in response to processor 620 executing software instructions contained in a computer-readable medium, such as memory 630. In alternative embodiments, hardwired circuitry may be used in place of or in combination with software instructions to implement features consistent with principles of the invention. Thus, implementations consistent with principles of the invention are not limited to any specific combination of hardware circuitry and software.

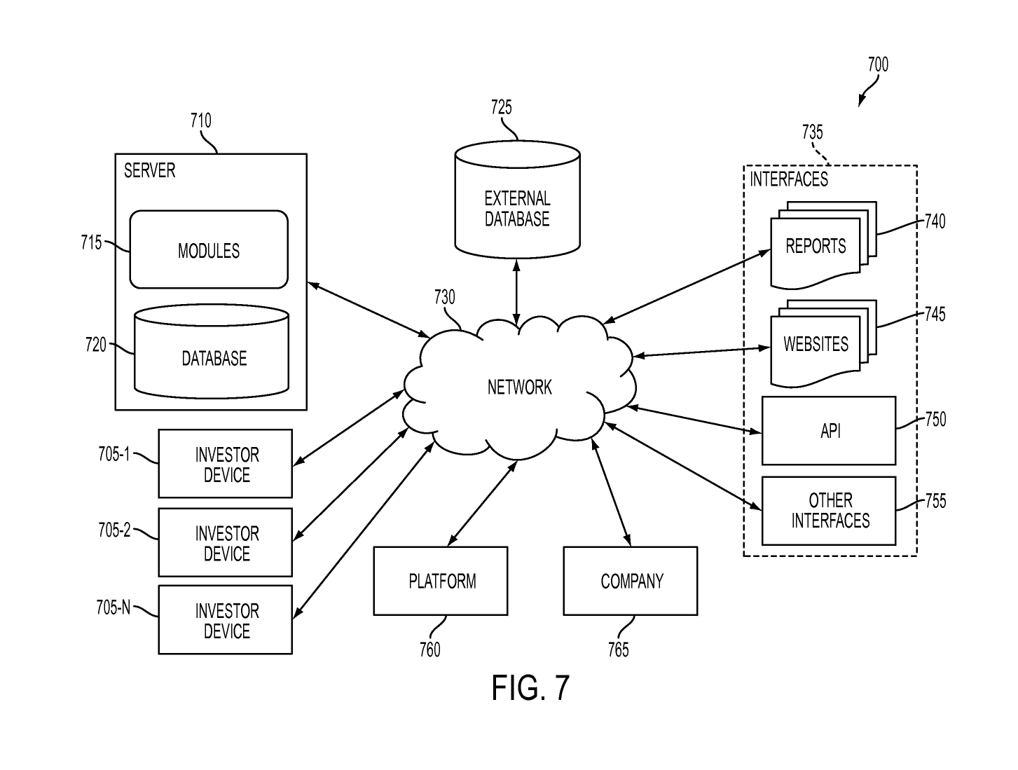

FIG. 7 depicts a schematic block diagram of an exemplary system in accordance with one or more embodiments. System 700 may include one or more investor devices 705-1, 705-2, . . . , 705-N, server 710, one or more modules 715, database 720, external database 725, network 730, one or more interfaces 735, one or more platforms 760, and one or more companies 765.

Investor devices 705-1 through 705-N may include any type of device, including a computing device, telephone, a fax machine, a mobile telephone, a laptop, tablet, or desktop computer having, a netbook, a video game device, a pager, a smart phone, an ultra-mobile personal computer (UMPC), or a personal data assistant (PDA). Investor devices 705-1 through 705-N may run one or more applications, such as Internet browsers, voice calls, video games, videoconferencing, and email, among others. Investor devices 705-1 through 705-N may be any combination of devices. These devices may be coupled to network 730.

Server 710 may also be any type of computing device coupled to network 730, including but not limited to a personal computer, a server computer, a series of server computers, a mini computer, and a mainframe computer, or combinations thereof. Server 710 may operate as a web server (or a series of servers) running a network operating system, examples of which may include but are not limited to Microsoft Windows Server, Novell NetWare, or Linux. Any of the features of server 710 may be also implemented in one or more additional servers coupled to network 730.

Server 710 may include one or more modules 715. The one or more modules 715 may be configured to send, process, and receive information at server 710. One or more modules 715 may send and receive information using any technique for sending and receiving information between processes or devices including using a scripting language, a remote procedure call, an email, a tweet, an application programming interface, Simple Object Access Protocol (SOAP) methods, Common Object Request Broker Architecture (CORBA), any interface for software components to communicate with each other, using any other known technique for sending information from a one device to another, or any combination thereof. One or more modules 715 may implement all or portions of the exemplary workflows depicted by FIGS. 1-4.

Server 710 may include database 720. Database 720 may be any type of database, including databases managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, and PostgreSQL. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored. Database 720 may be implemented as database 158.

External database 725 may include any or all of the features of database 720. External database 725 may be located outside of server 710, operated by another entity than the entity operating server 710, and any combination thereof. External database 725 may include a criminal-background database, a securities regulatory database, any other type of database, and any combination thereof. External database may be coupled to network 730.

Network 730 may provide network access, data transport and other services to the devices coupled to it. In general, network 730 may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, network 730 may implement one or more of a GSM architecture, a General Packet Radio Service (GPRS) architecture, a Universal Mobile Telecommunications System (UMTS) architecture, and an evolution of UMTS referred to as Long Term Evolution (LTE). Network 730 may, again as an alternative or in conjunction with one or more of the above, implement a WiMAX architecture defined by the WiMAX forum. Network 730 may also comprise, for instance, a local area network (LAN), a wide area network (WAN), the Internet, a virtual LAN (VLAN), an enterprise LAN, a layer 3 virtual private network (VPN), an enterprise IP network, a cellular network, a telecommunications network, a broadcast network, a radio broadcast network, a television broadcast network, a social network, or any combination thereof.

System 700 may include one or more interfaces 735, any one or combination of which may be coupled to network 730. One or more interfaces 735 may include one or more reports 740, one or more websites 745, one or more APIs 750, one or more other interfaces 755, and any combination thereof. The one or more interfaces 735 may include the interfaces described herein, including, but not limited to, the any or all of the interfaces associated with all, any, or portions of the exemplary workflows depicted in FIGS. 1-4 or all, any, or portions of the exemplary interfaces depicted in FIGS. 5, 8-10, 11A-11B, 12A-12N, 13A-13B, and 14A-14M.

One or more websites 745 may be any type of website or web page. For example, one or more websites 745 may be coded using hypertext markup language (“HTML”), XML, XHTML, JavaScript, Java, Perl, Visual Basic, Hypertext Preprocessor scripts (“PHP”), Active Server Page scripts (“ASP”), common gate interface (“CGI”) scripts, server side includes, and combinations thereof. One or more websites 745 may include the exemplary interfaces depicted in FIGS. 5, 8-10, 11A-11B, 12A-12N, 13A-13B, and 14A-14M.

One or more platforms 760 and one or more companies 765 may be coupled to network 730.

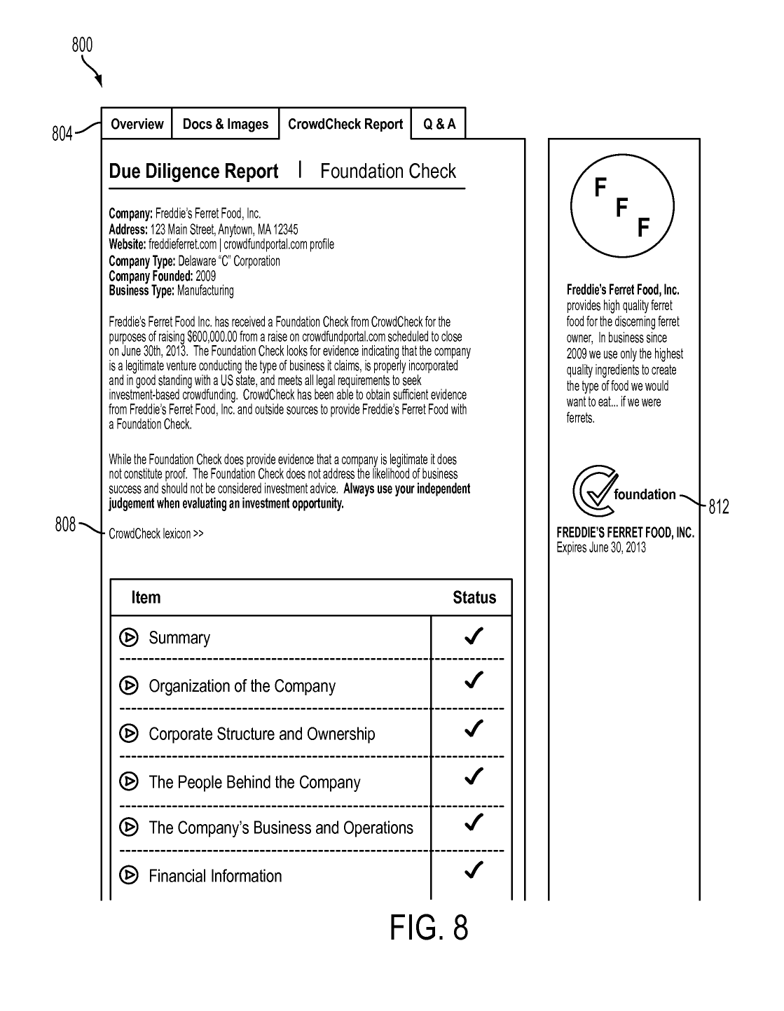

FIG. 8 is an alternative embodiment of the interface used by a graphical interface 800 of the disclosed subject matter presenting information on a platform's webpage. In this embodiment the report is one of several types of information on the investment platform and is accessible via clicking on a “tab” within the company's profile 804. This embodiment displays the ability of the disclosed subject matter to allow users to instantly access additional information, including relevant definitions and educational materials via hyperlink or other means 808. This embodiment also displays the use of a “badge” that can appear in various settings, including but not limited to appearing on the company's profile on the investment platforms site independent of the report, to show investors information such as the level of review performed on the company and the expiration date for the review 812.

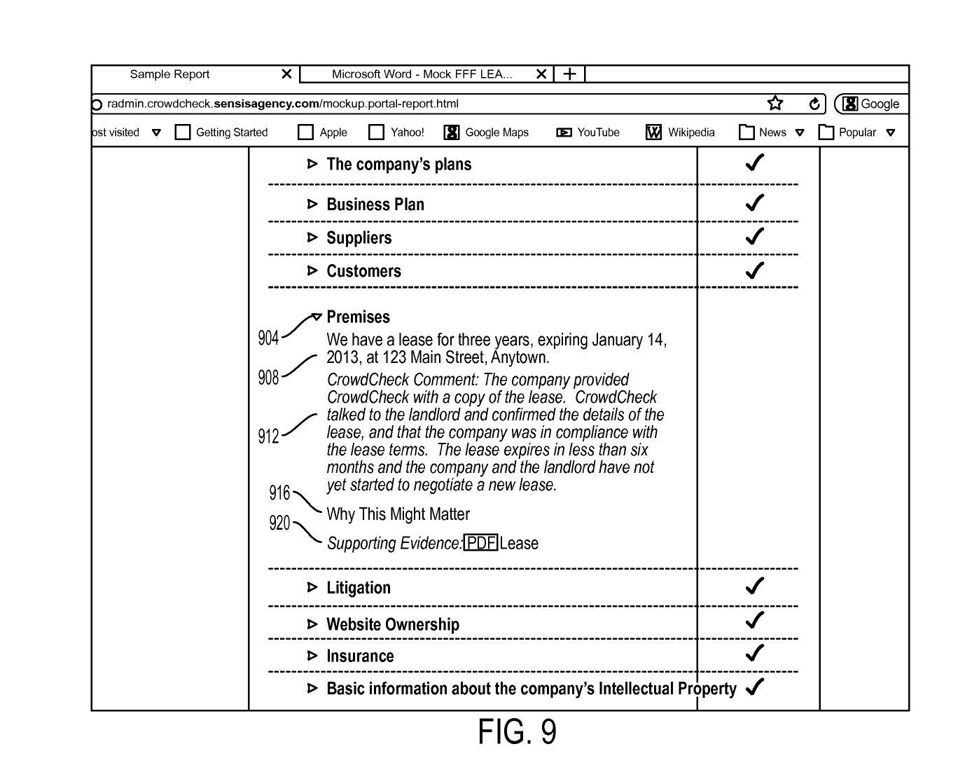

FIG. 9 is an alternative embodiment of the interface used by a graphical interface 900 of the disclosed subject matter presenting information on a platform's webpage. This particular embodiment displays the ability of a user to access information on a specific access of the company by selecting via input, including but not limited to electronic input via a “mouse”, specific topics about the company seeking investment they are interested in 904. This embodiment also shows how the user can access different and complimentary types of information from the report, including the statements of the company seeking investment 908, the statement of the company performing the due diligence investigation 912, general investor education 916, and supporting documentation in human readable formats including but not limited to PDF 920. This information is all accessible via means including but not limited to hyperlinks and can all be accessed by the user without leaving the investment platform.

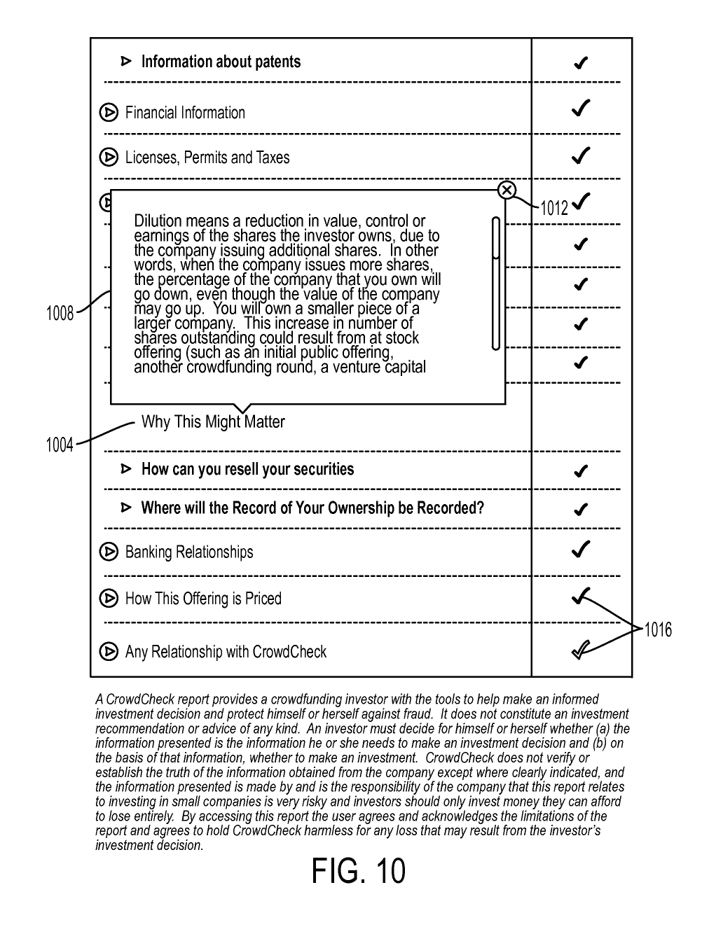

FIG. 10 is an alternative embodiment of the interface used by a graphical interface 1000 of the disclosed subject matter presenting information on a platform's webpage. This particular embodiment displays the result of a user entering an input to see additional educational information 1004. This results in the information being provided to the user by means including but not limited to an additional window within the report containing educational information 1008 that can be viewed without leaving the report and closed by the user 1012. In addition, this embodiment displays the disclosed subject matter's ability to indicate, in a non-verbal/non-text manner, whether certain topics merit special intention by the user 1016. For example, a solid checkmark, like the one in 1016, may indicate one status, such as a confirmed status, and the blank checkmark, like the one in 1016, may indicate another status as an unconfirmed status.

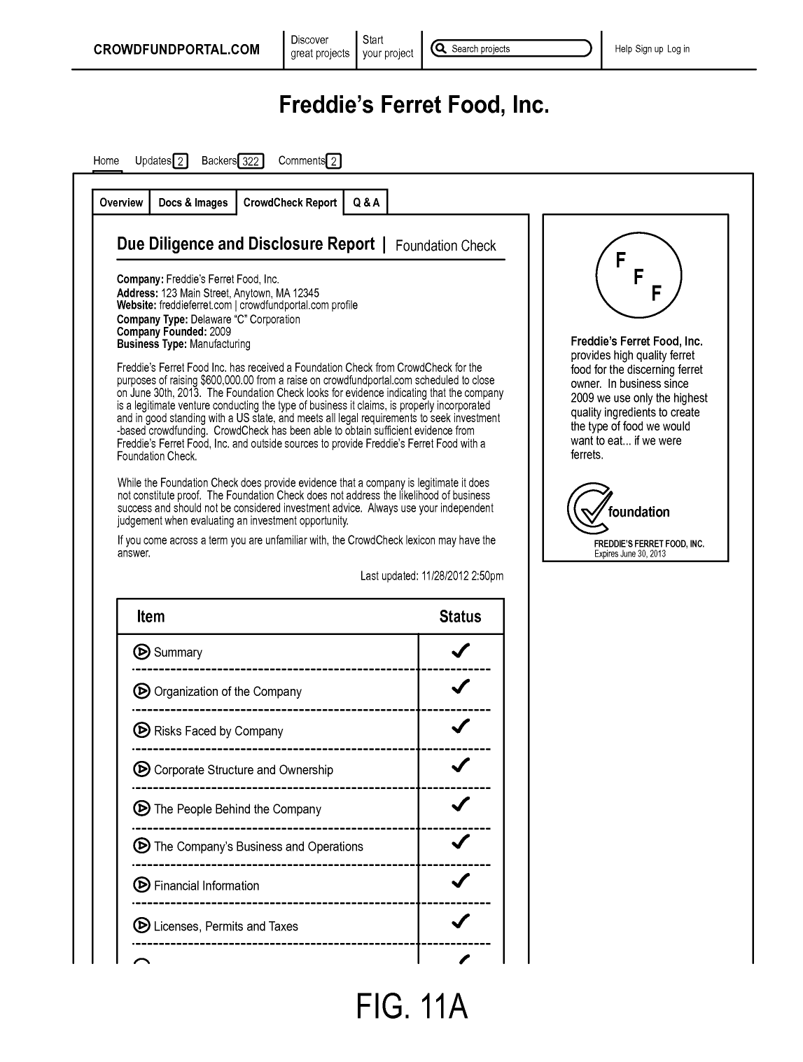

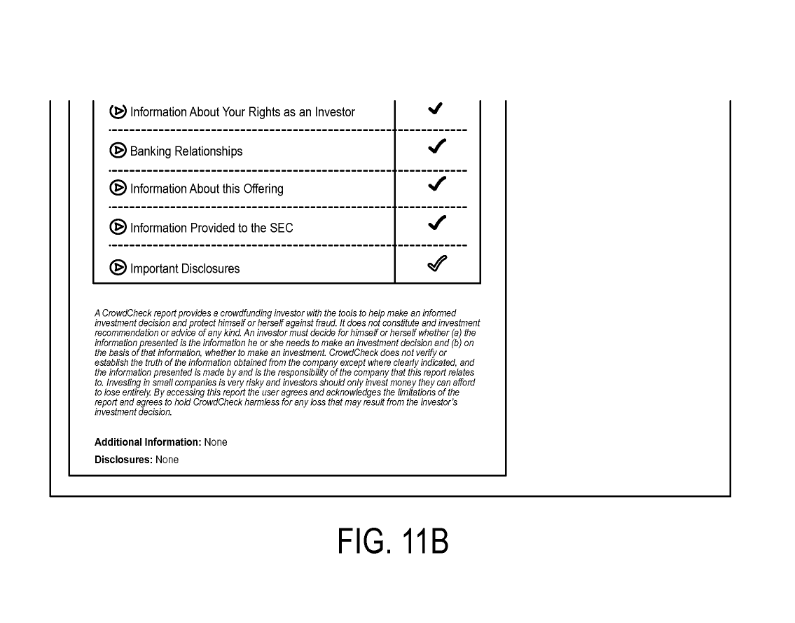

FIGS. 11A-11B depict a visual representation of an alternative embodiment of the interface used by the public to receive information from the disclosed subject matter on a webpage. FIGS. 11A-11B may represent different portions of the same interface, in which FIG. 11B is a continuation FIG. 11A. For example, FIGS. 11A and 11B may be presented in the same web page, with FIG. 11A being followed by FIG. 11B. FIGS. 11A-11B present a view in which the expandable portions of the report are collapsed. However, it is not required that the elements of the report in FIGS. 11A-11B be expandable.

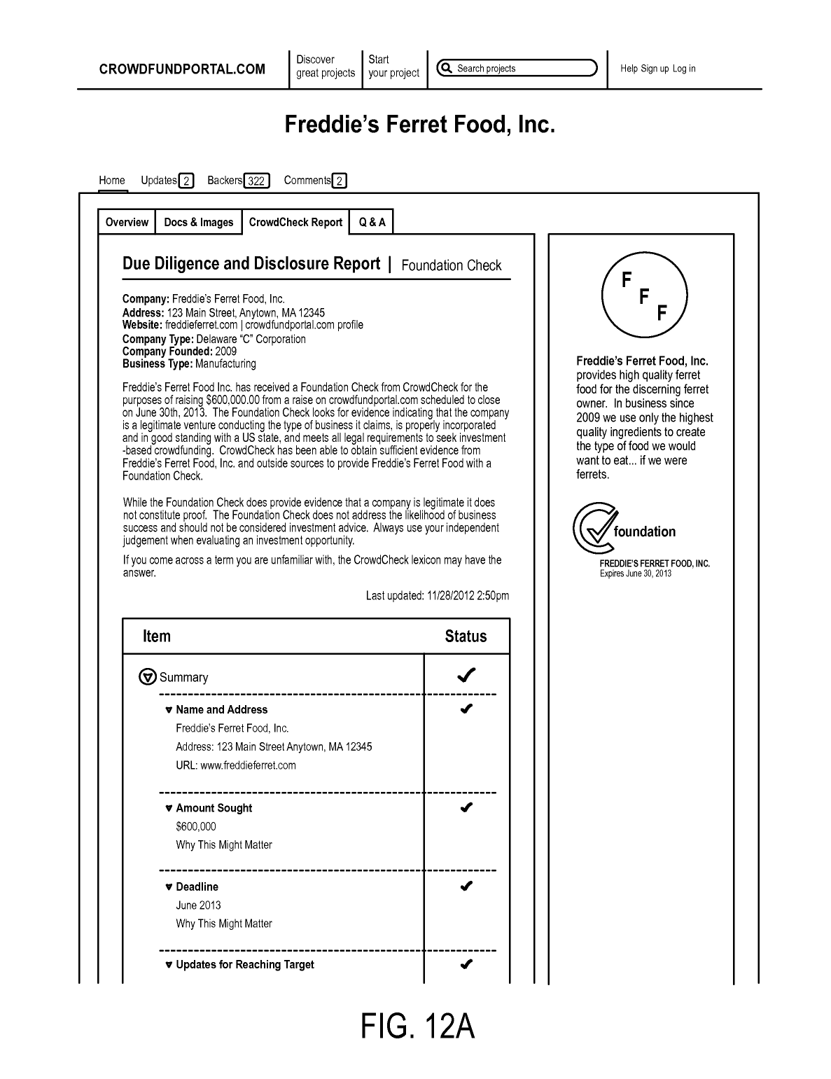

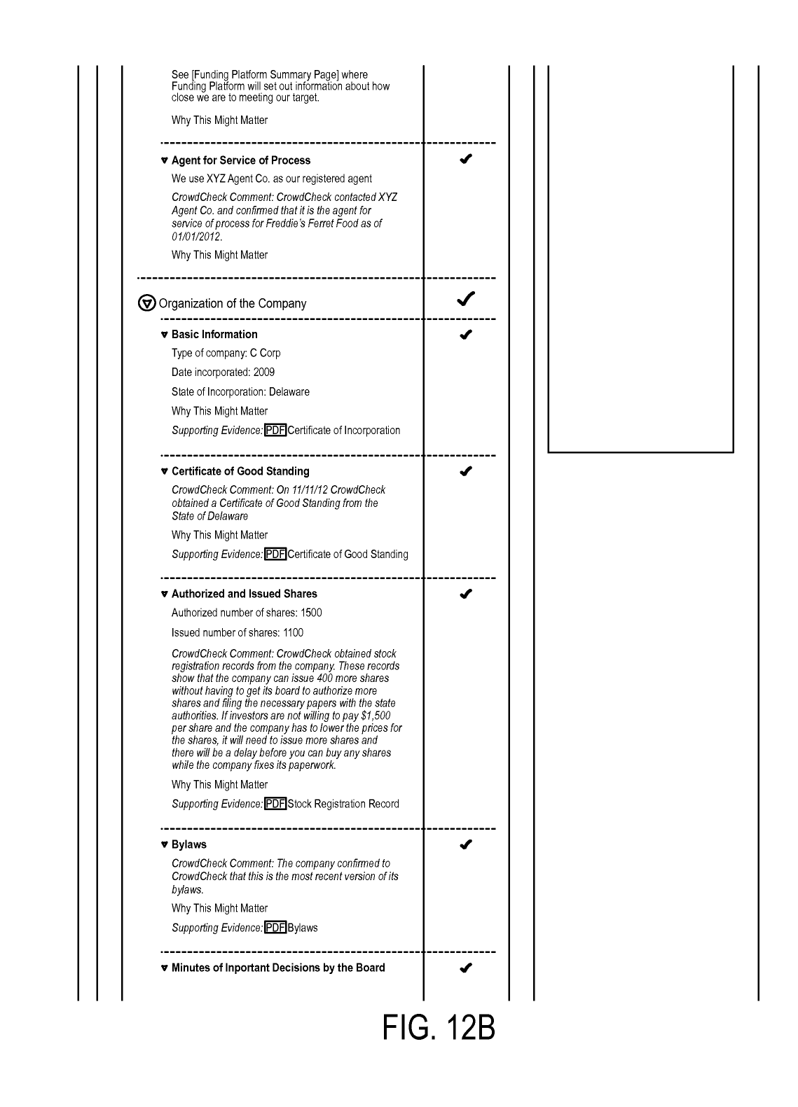

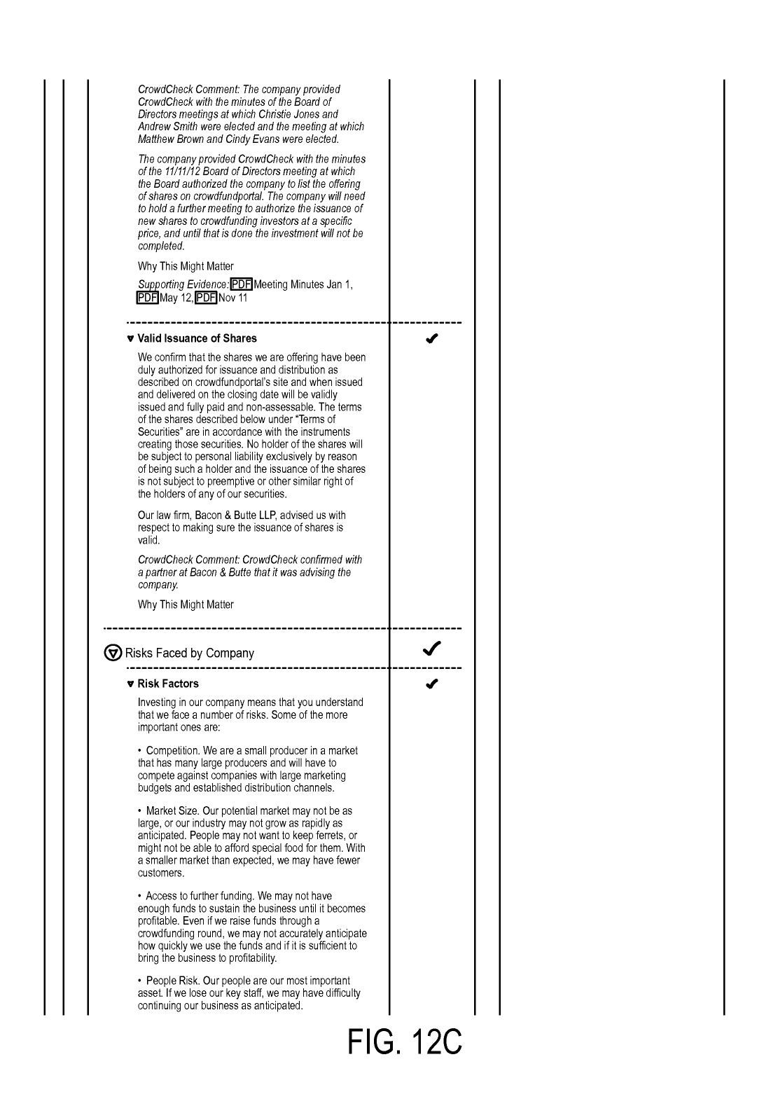

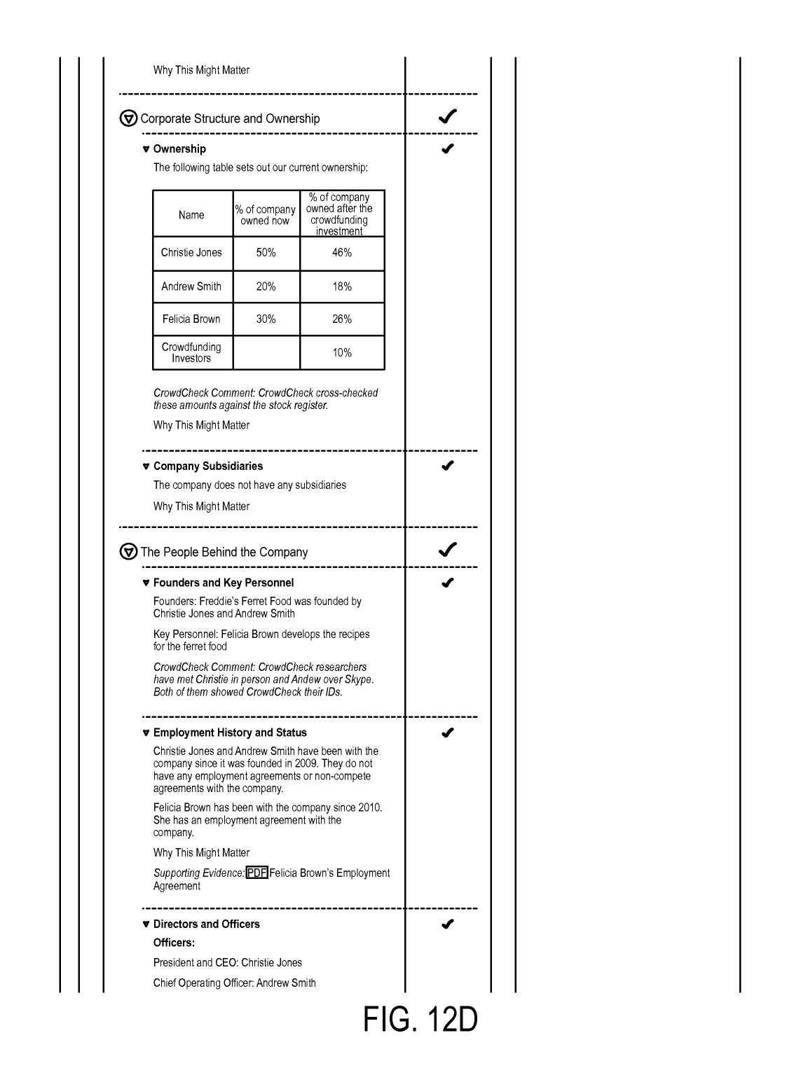

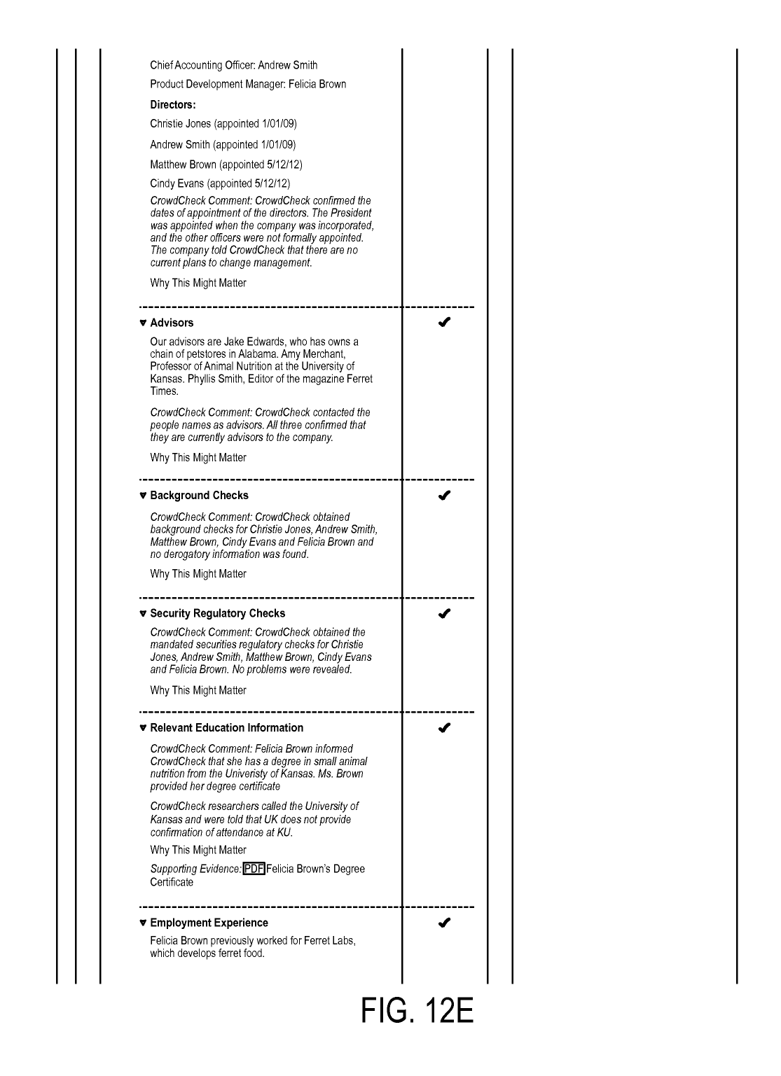

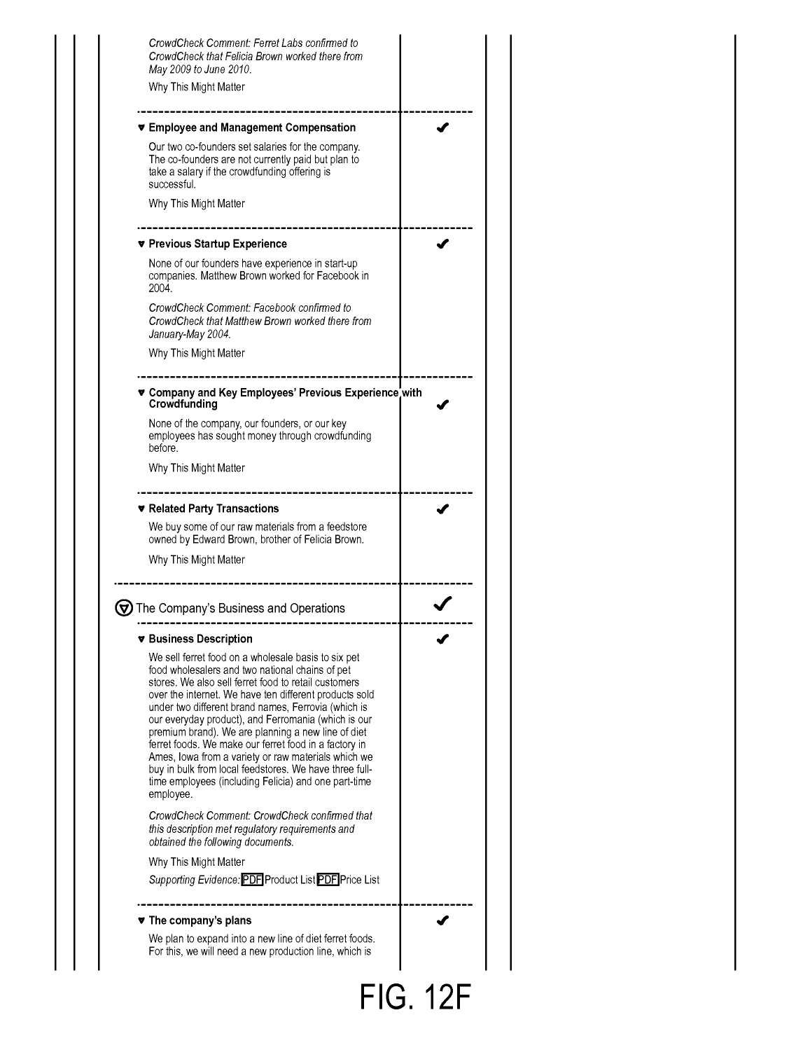

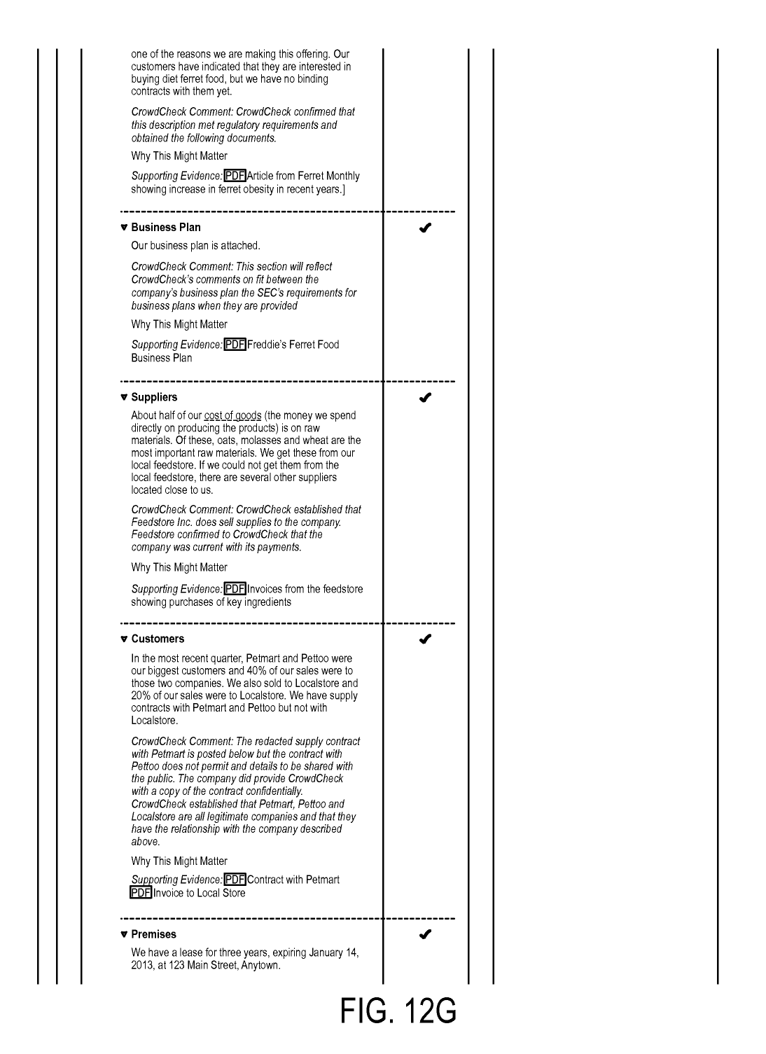

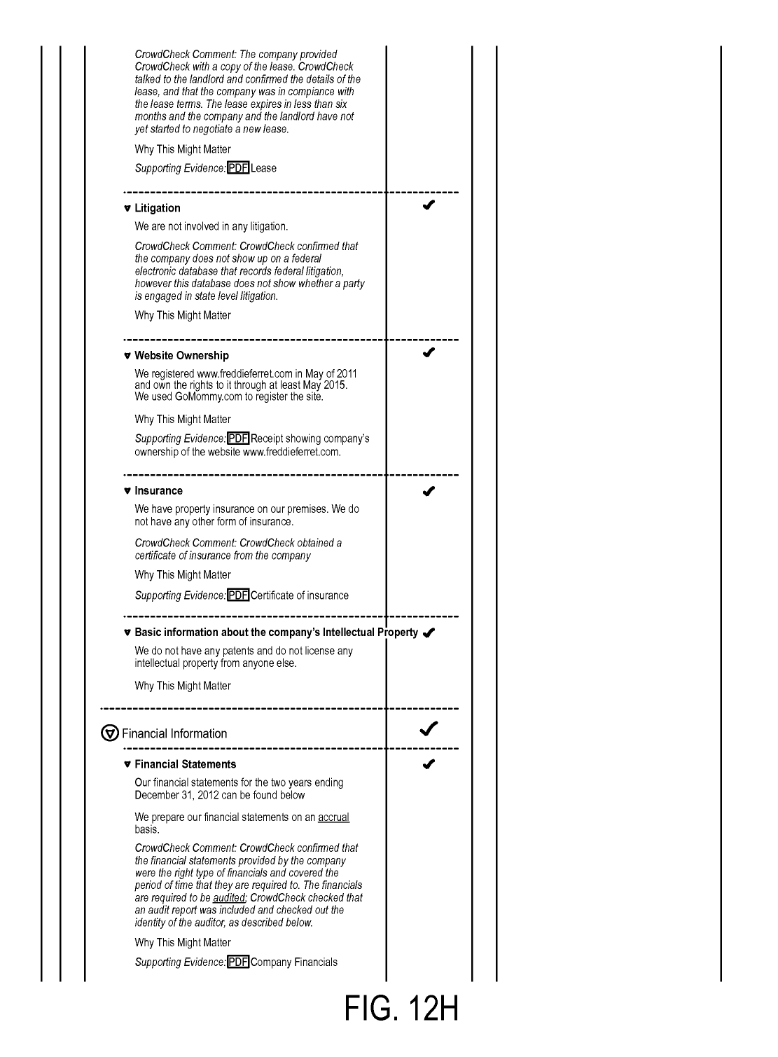

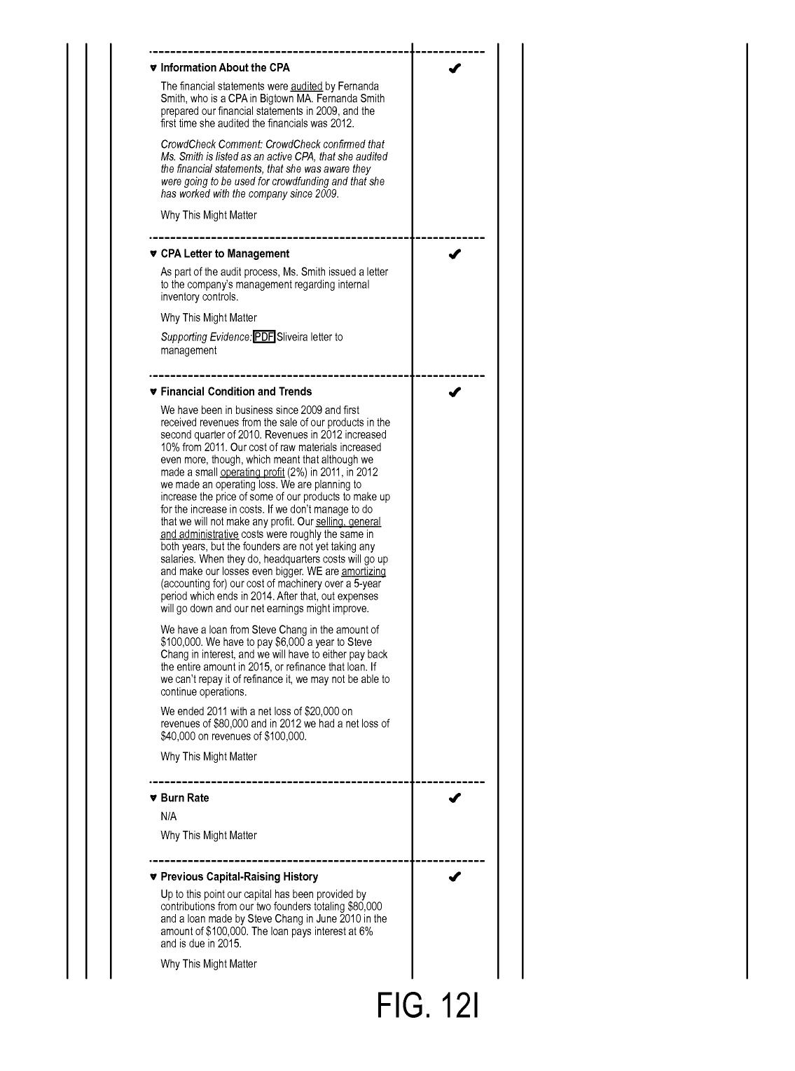

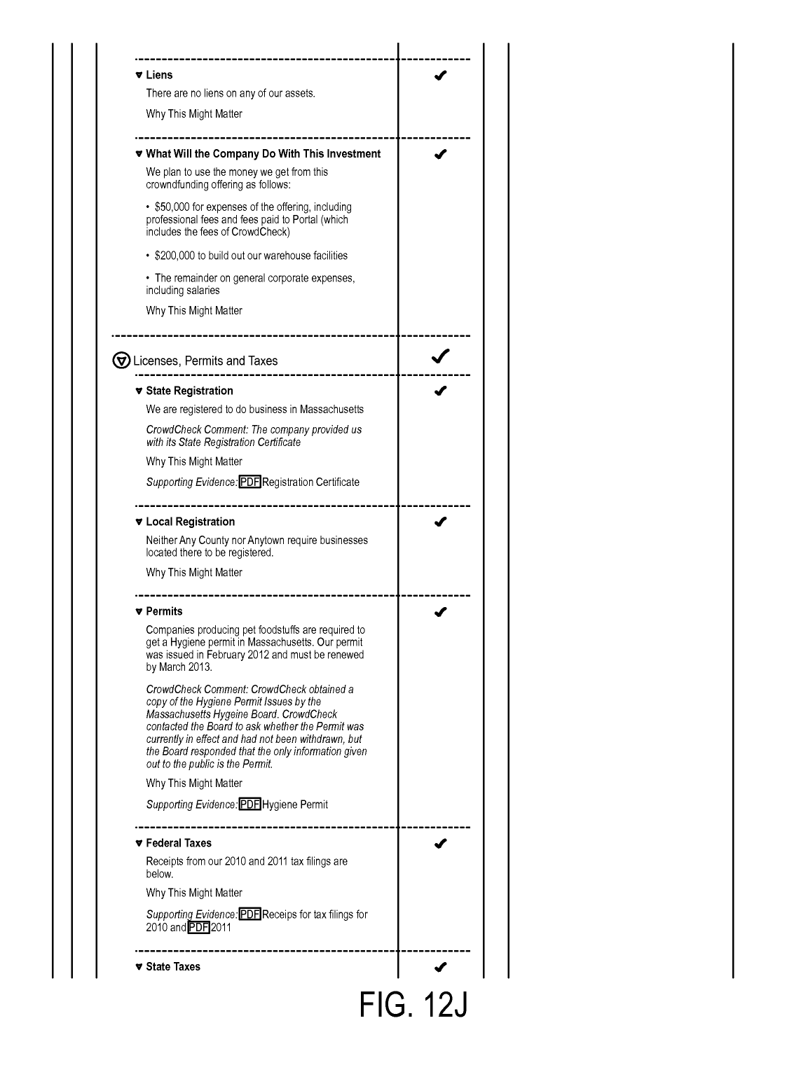

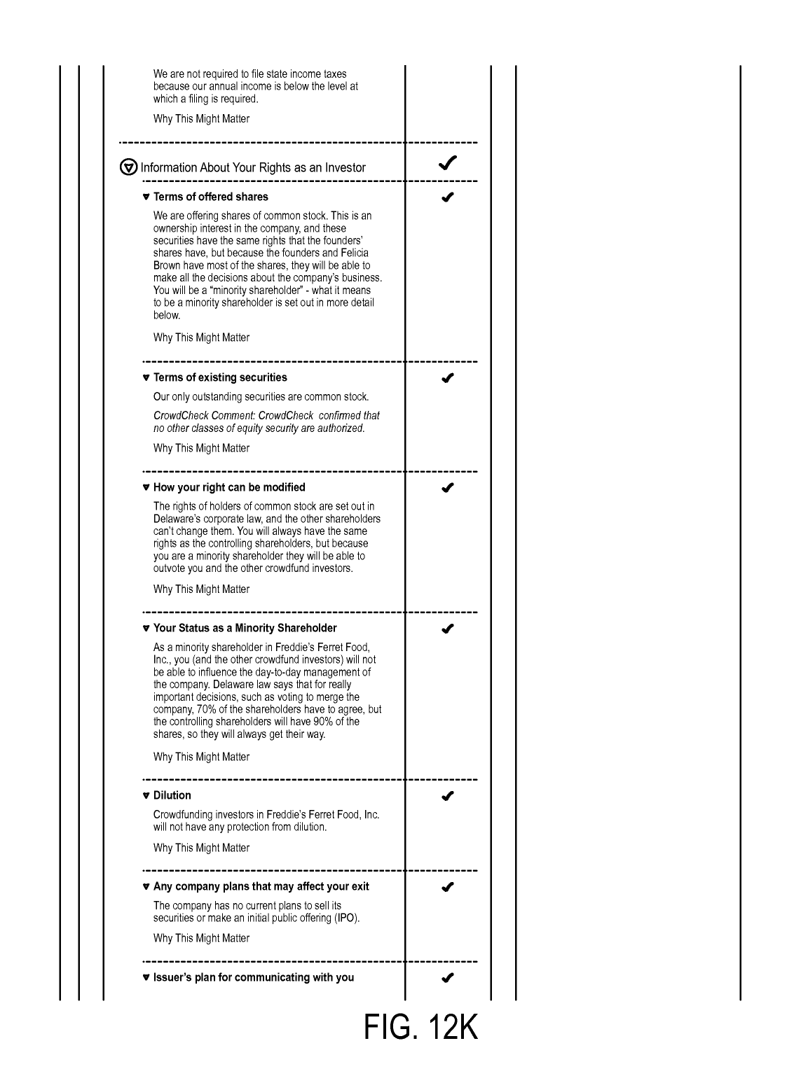

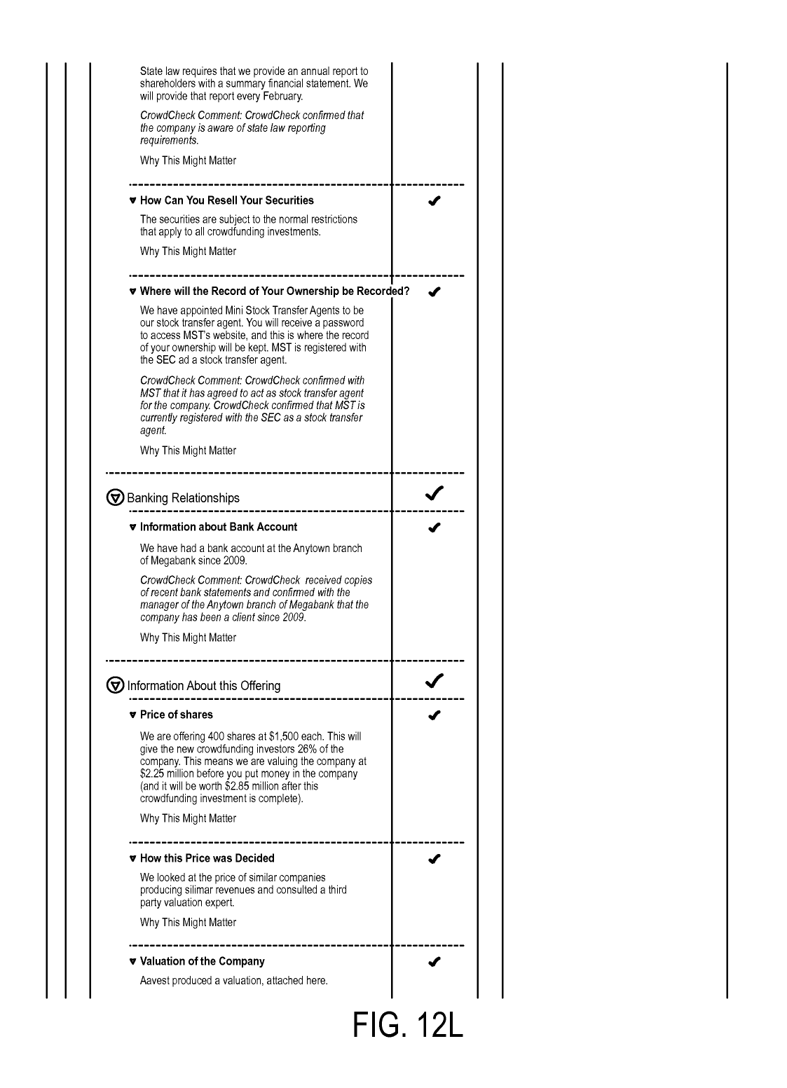

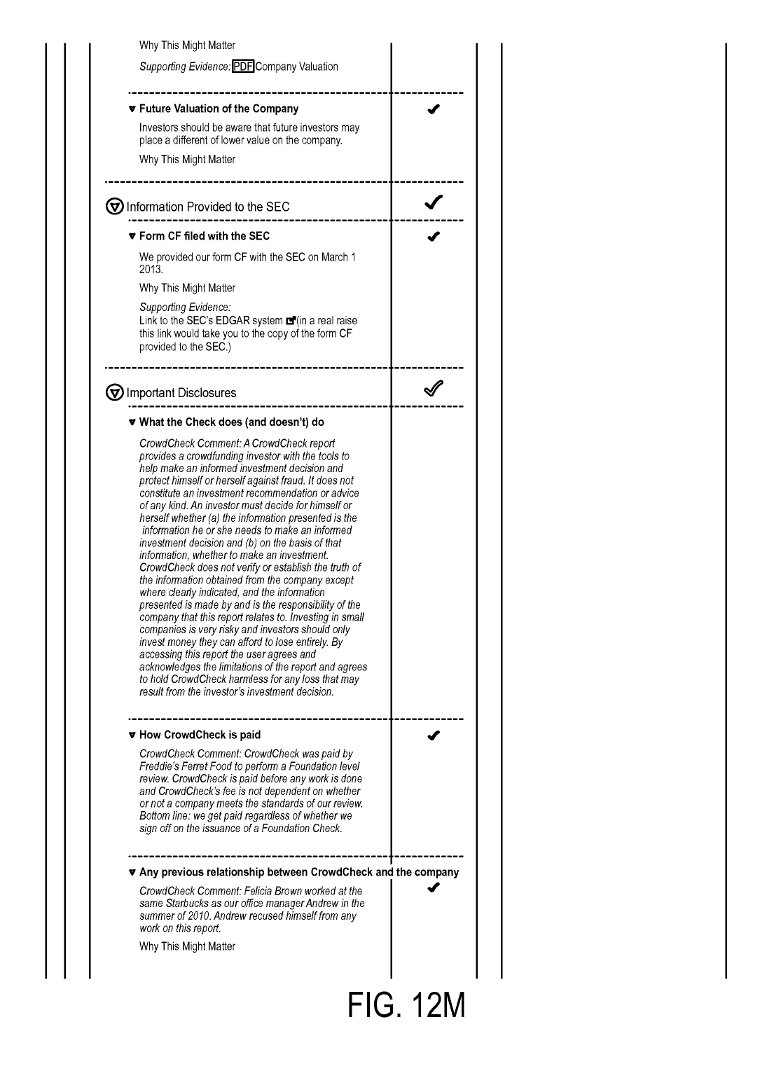

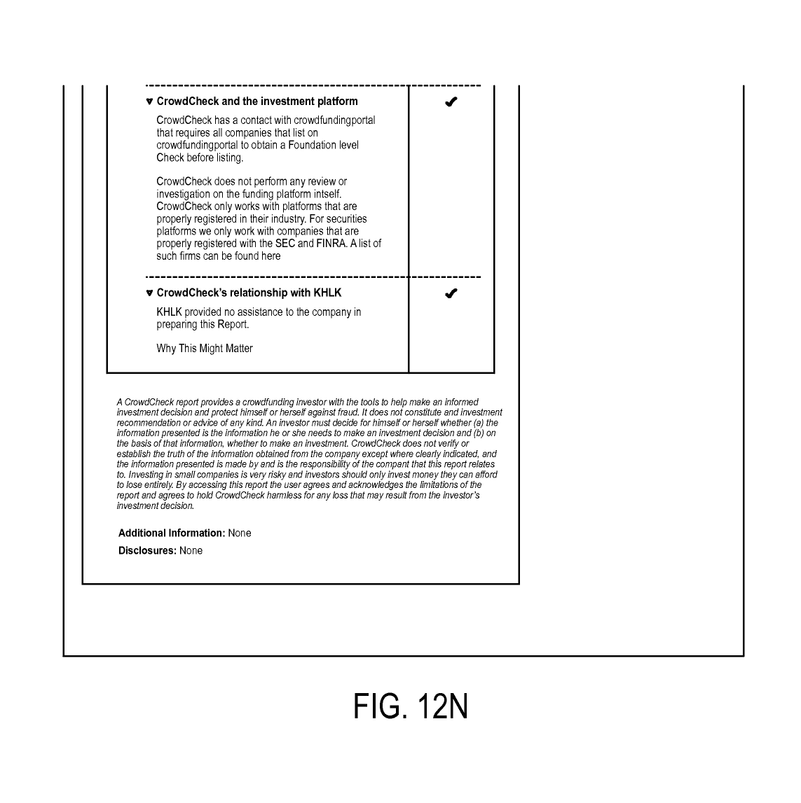

FIGS. 12A-12N depict a visual representation of an alternative embodiment of the interface used by the public to receive information from the disclosed subject matter on a webpage. FIGS. 12A-12N may represent different portions of the same interface, in which FIG. 12B is a continuation FIG. 12A, FIG. 12C is a continuation of FIG. 12B, and so on until ending with FIG. 12N being a continuation of FIG. 12M. For example, FIGS. 12A-12N may be presented in the same web page, with FIG. 12A being followed by FIG. 12B being followed by FIG. 12C, and so on, until ending with FIG. 12N. FIGS. 12A-12N present a view in which the expandable portions of the report are expanded, including subsections. However, it is not required that all of the portions and/or subsections of the report in FIGS. 12A-12N be expanded at the same time.

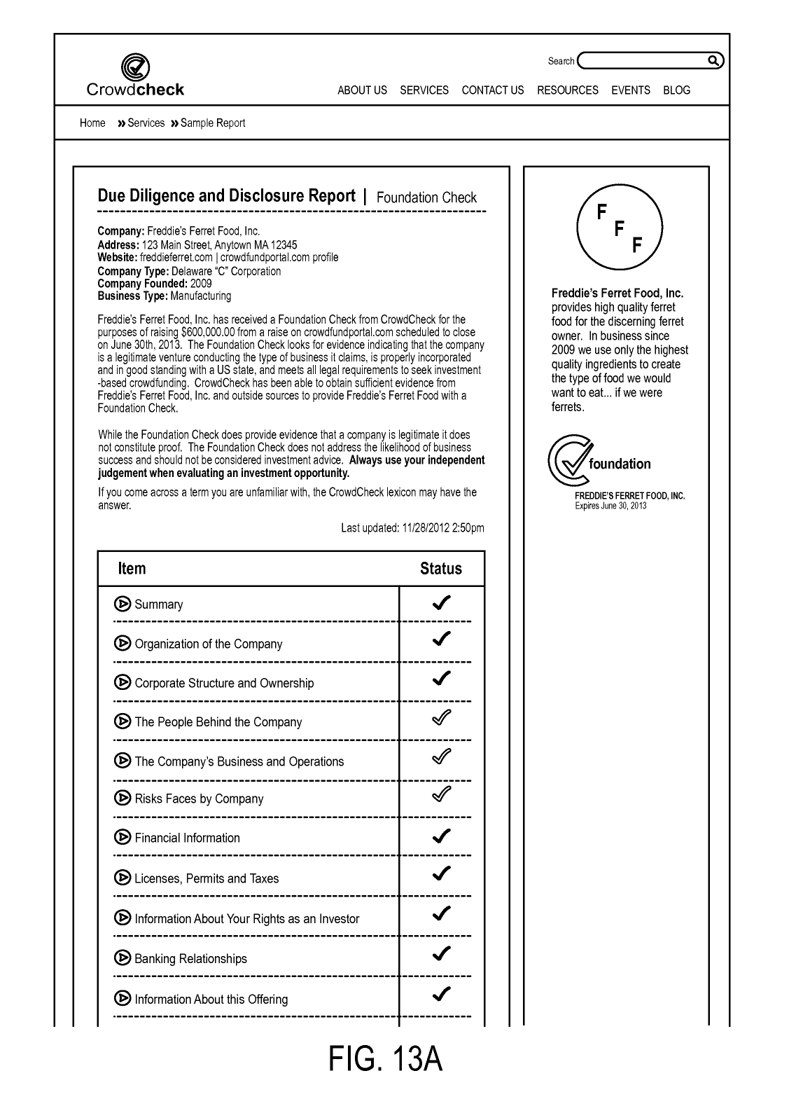

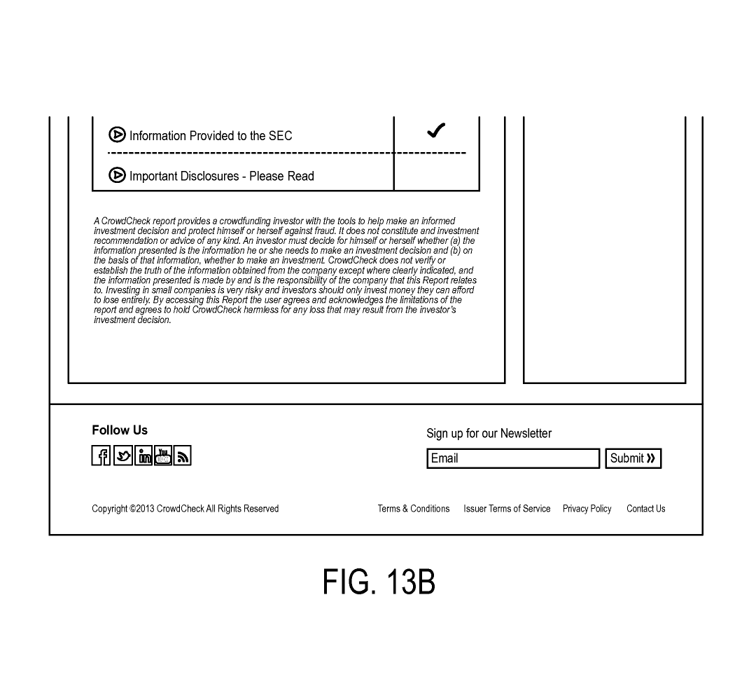

FIGS. 13A-13B depict a visual representation of an alternative embodiment of the interface used by the public to receive information from the disclosed subject matter on a webpage. FIGS. 13A-13B may represent different portions of the same interface, in which FIG. 13B is a continuation FIG. 13A. For example, FIGS. 13A and 13B may be presented in the same web page, with FIG. 13A being followed by FIG. 13B. FIGS. 13A-13B present a view in which the expandable portions of the report are collapsed. However, it is not required that the elements of the report in FIGS. 13A-13B be expandable.

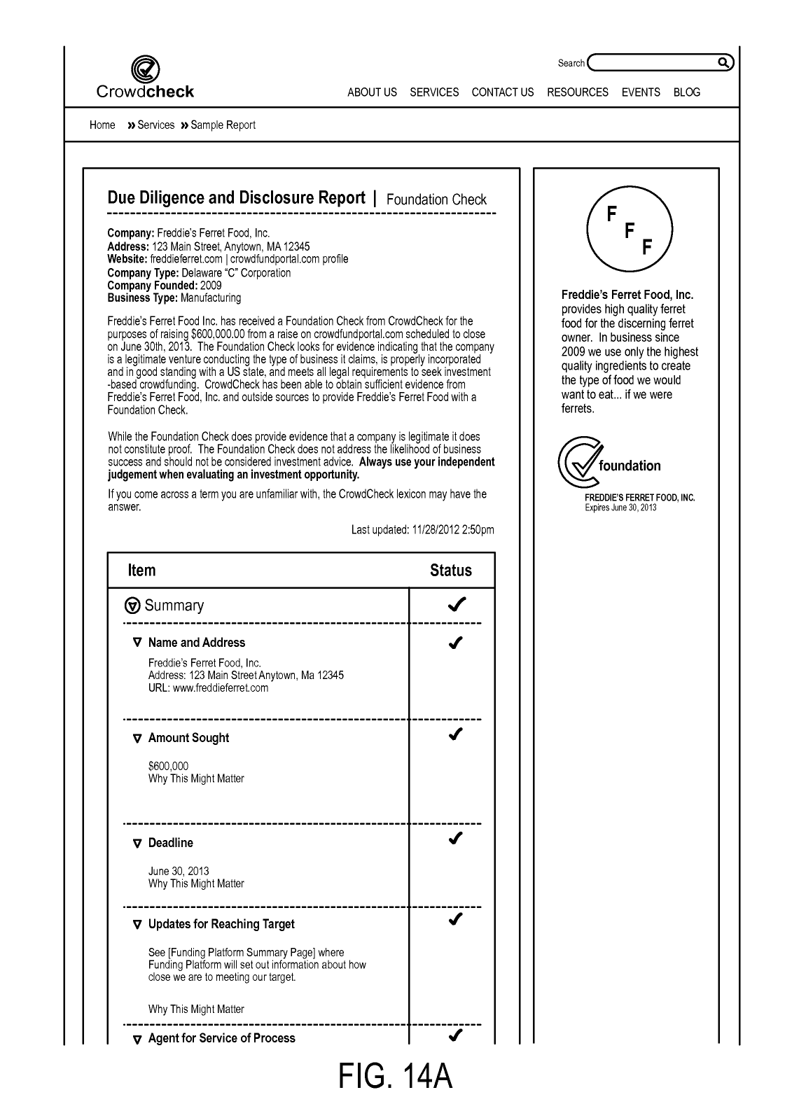

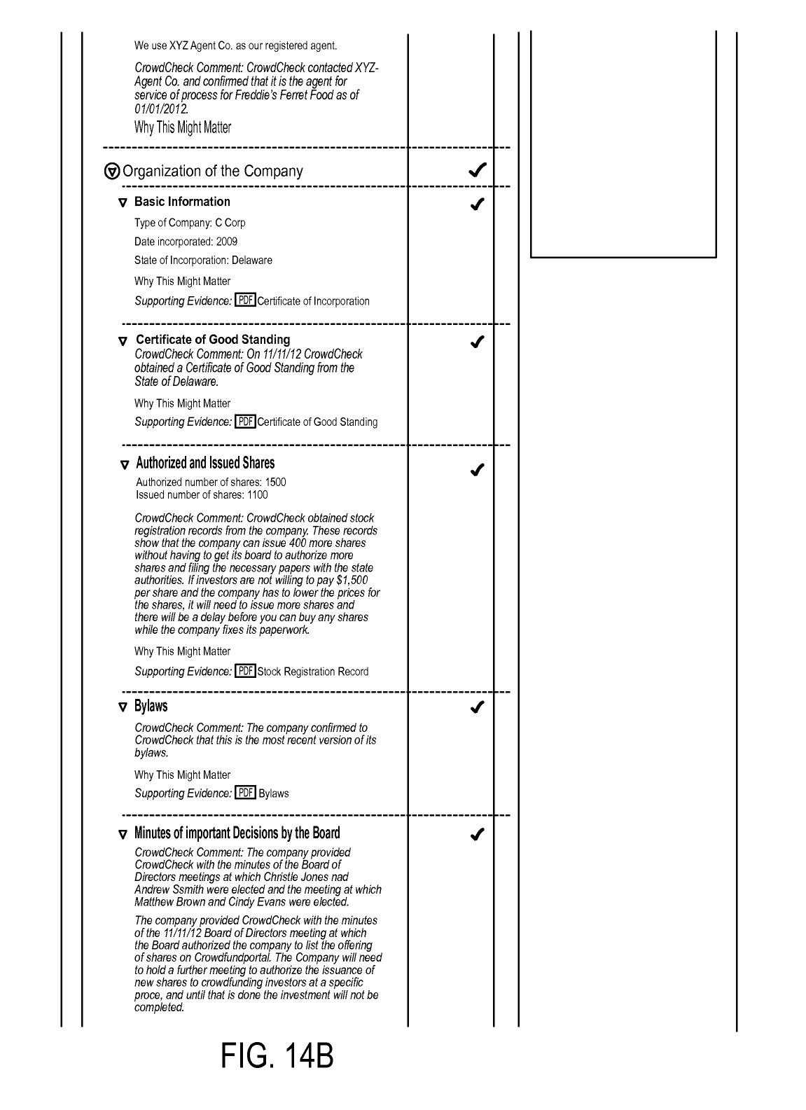

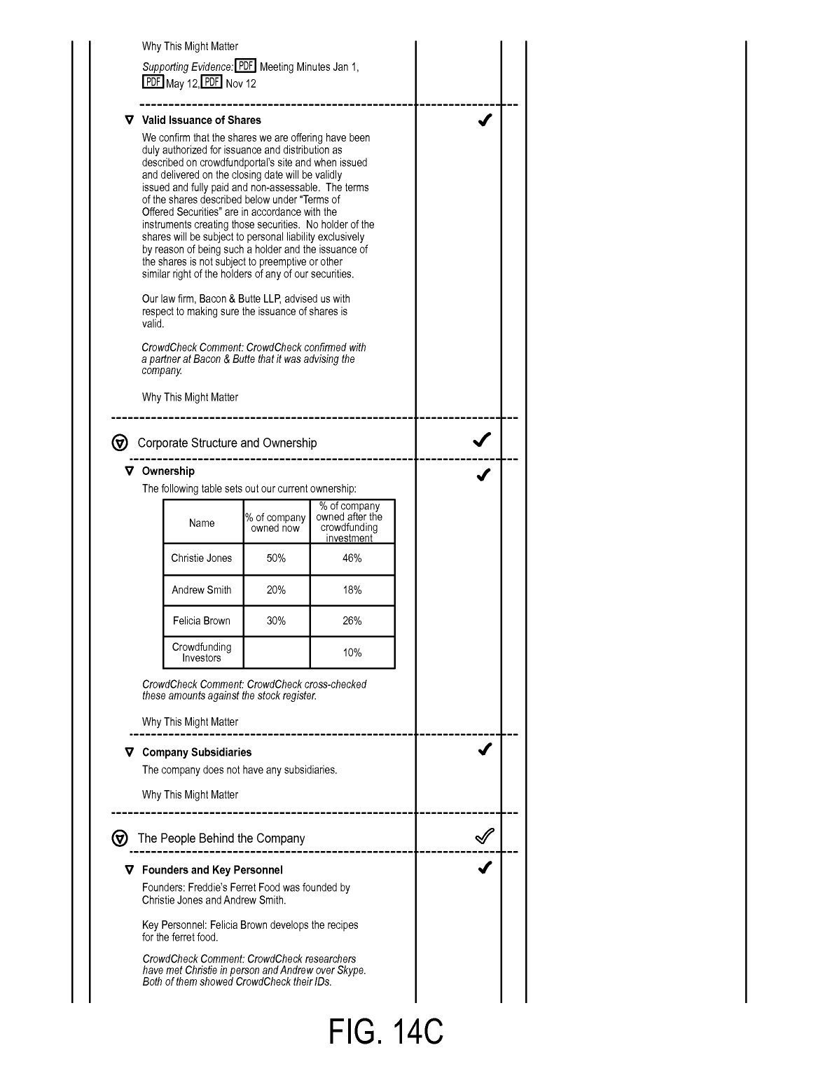

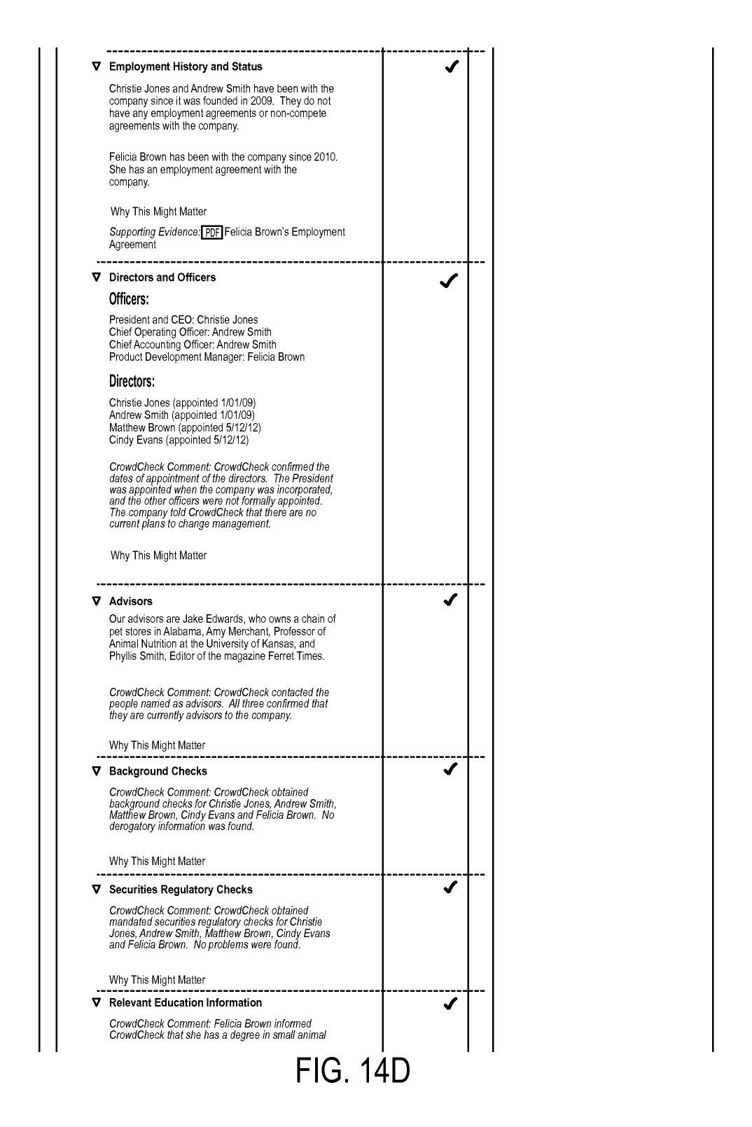

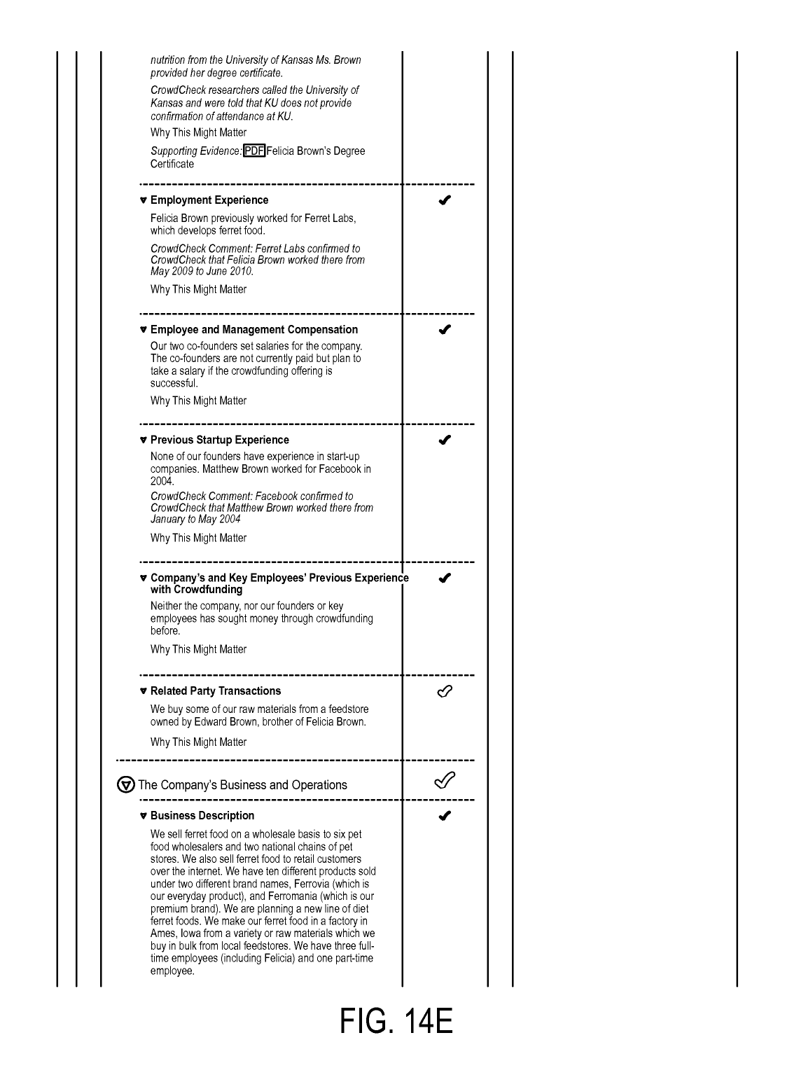

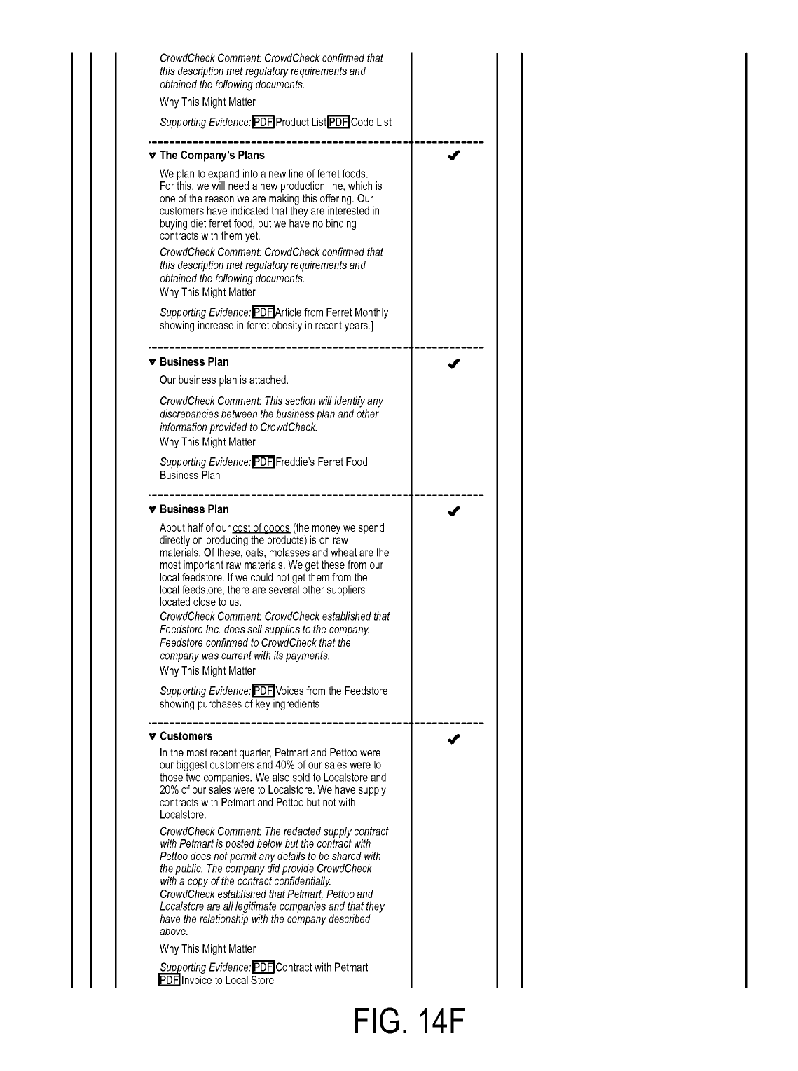

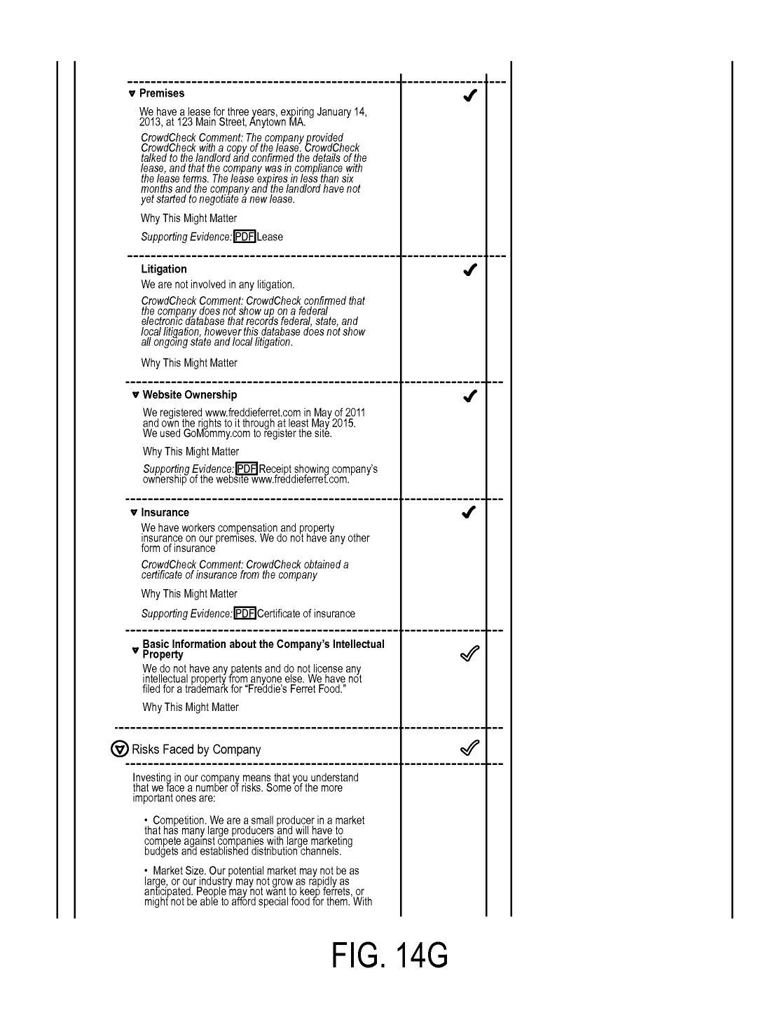

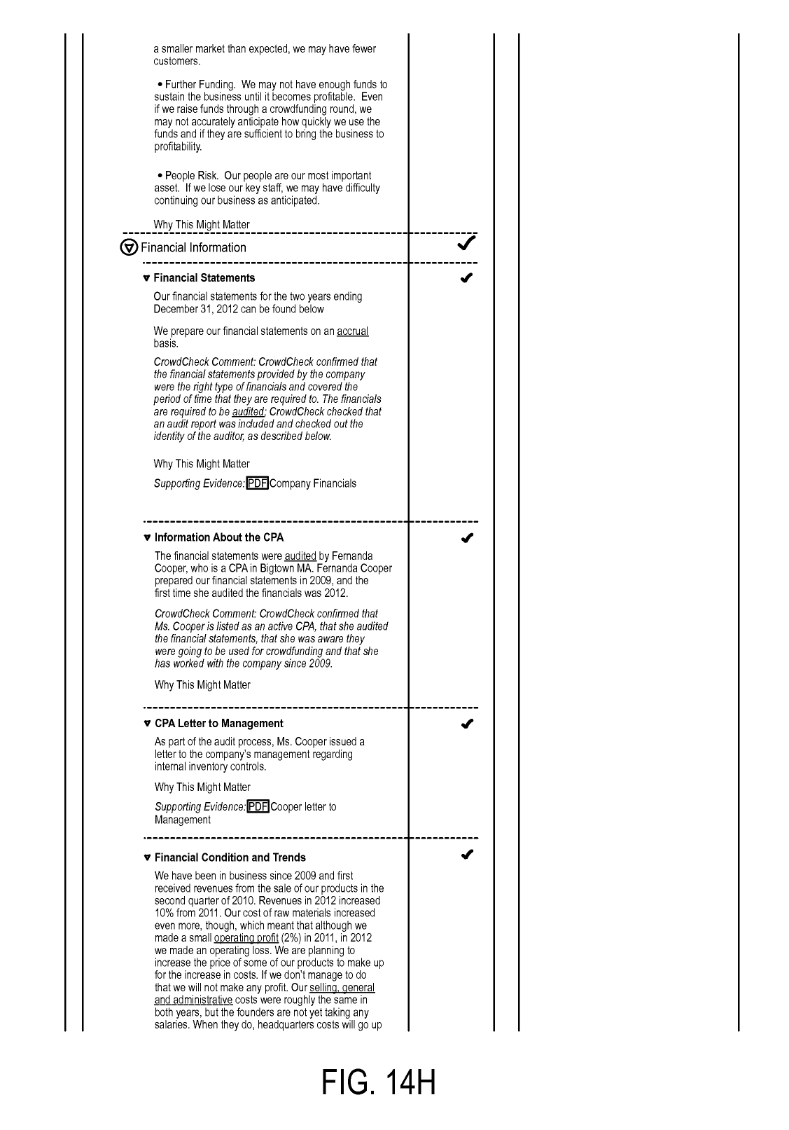

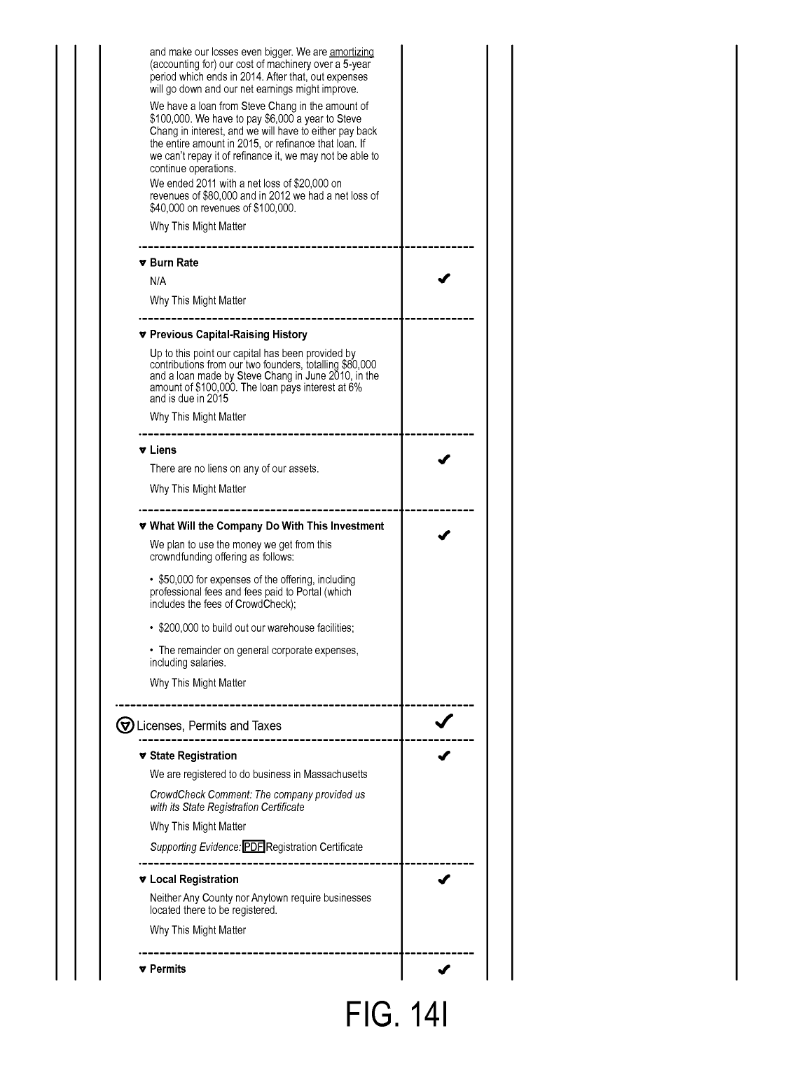

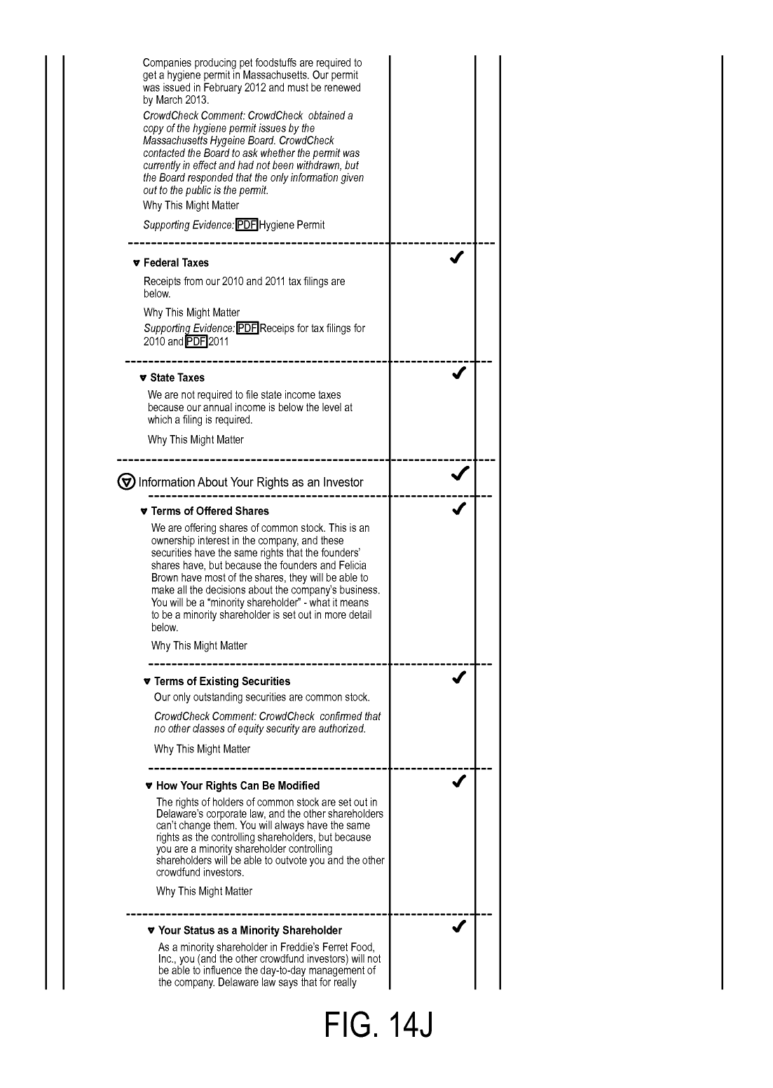

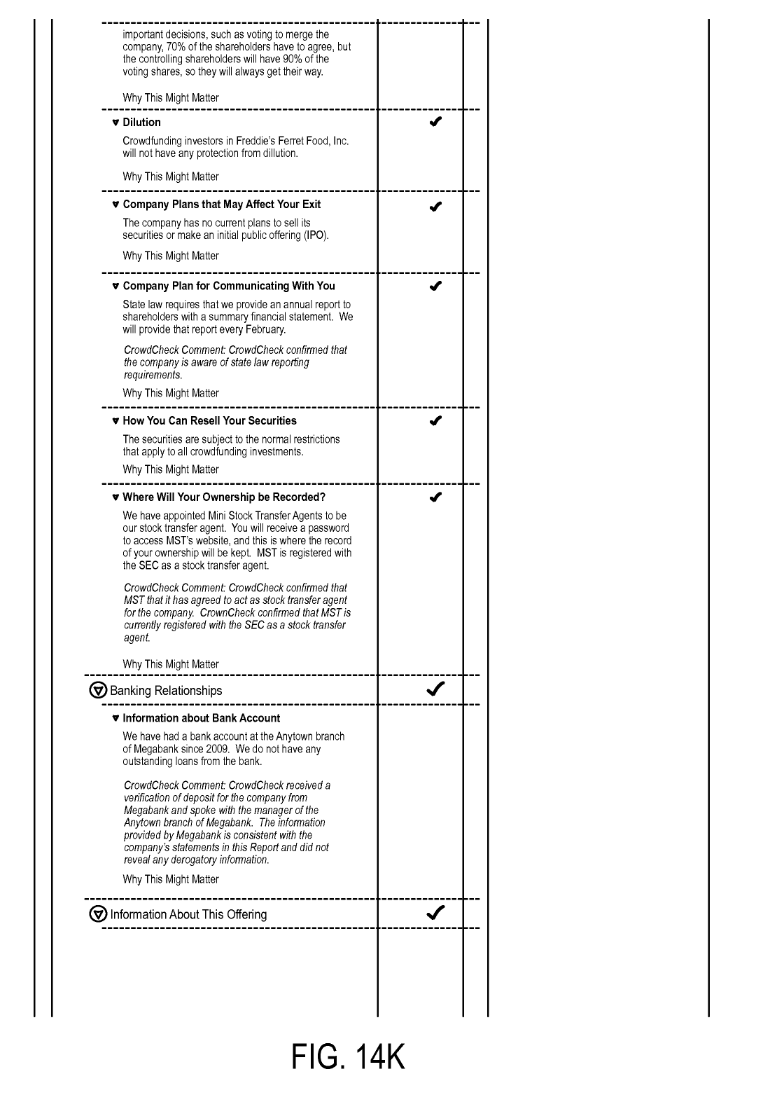

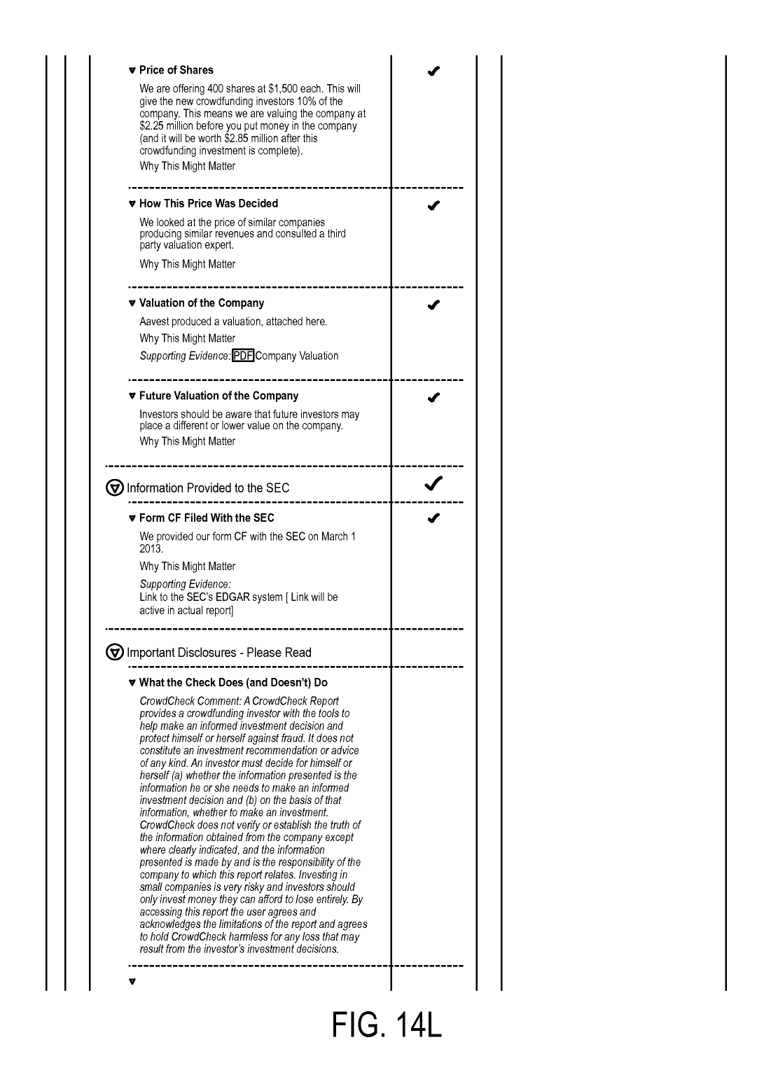

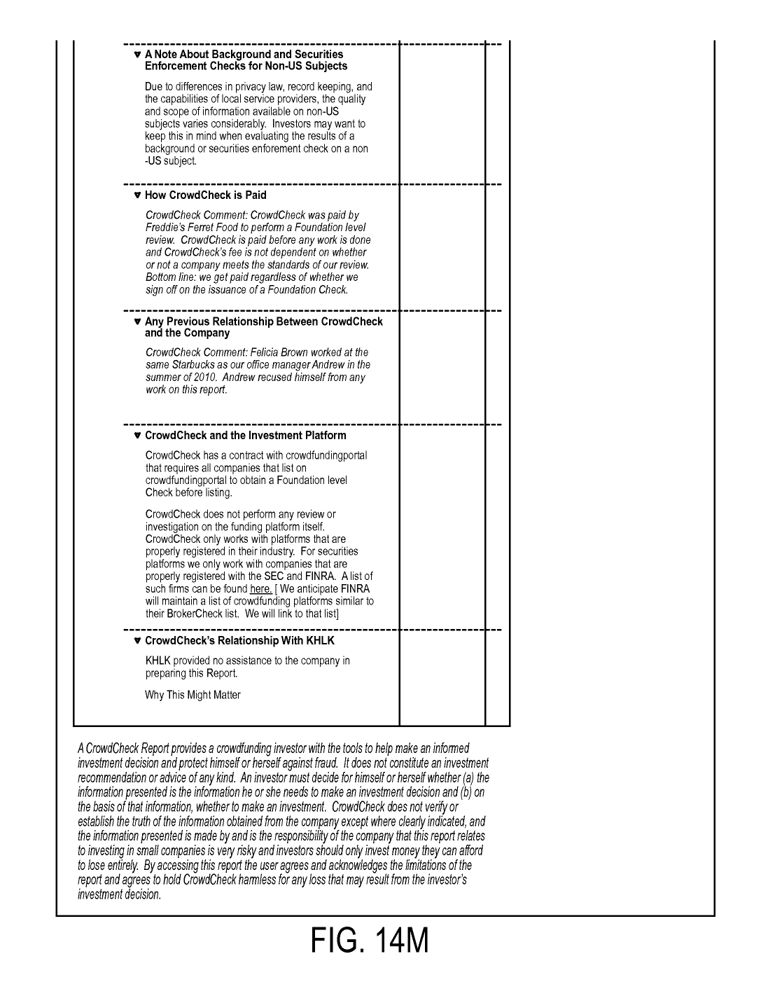

FIGS. 14A-14M depict a visual representation of an alternative embodiment of the interface used by the public to receive information from the disclosed subject matter on a webpage. FIGS. 14A-14M may represent different portions of the same interface, in which FIG. 14B is a continuation FIG. 14A, FIG. 14C is a continuation of FIG. 14B, and so on until ending with FIG. 14M being a continuation of FIG. 14L. For example, FIGS. 14A-14M may be presented in the same web page, with FIG. 14A being followed by FIG. 14B being followed by FIG. 14C, and so on, until ending with FIG. 14M. FIGS. 14A-14M present a view in which the expandable portions of the report are expanded, including subsections. However, it is not required that all of the portions and/or subsections of the report in FIGS. 14A-14M be expanded at the same time.

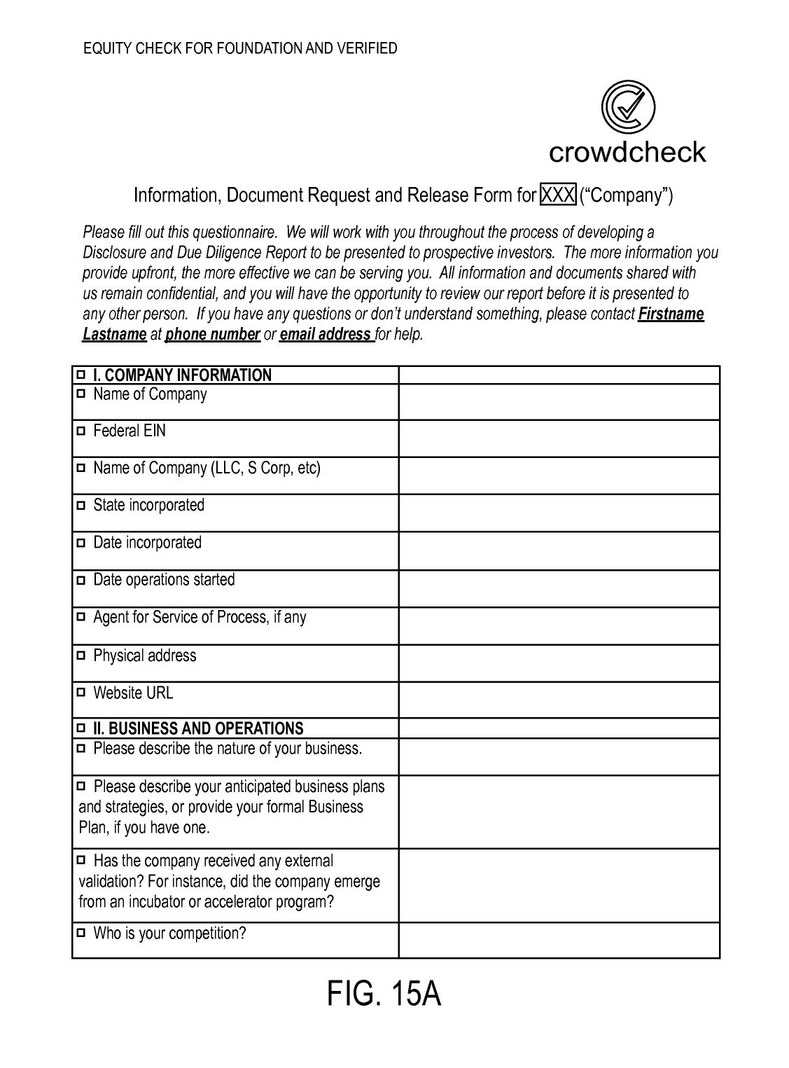

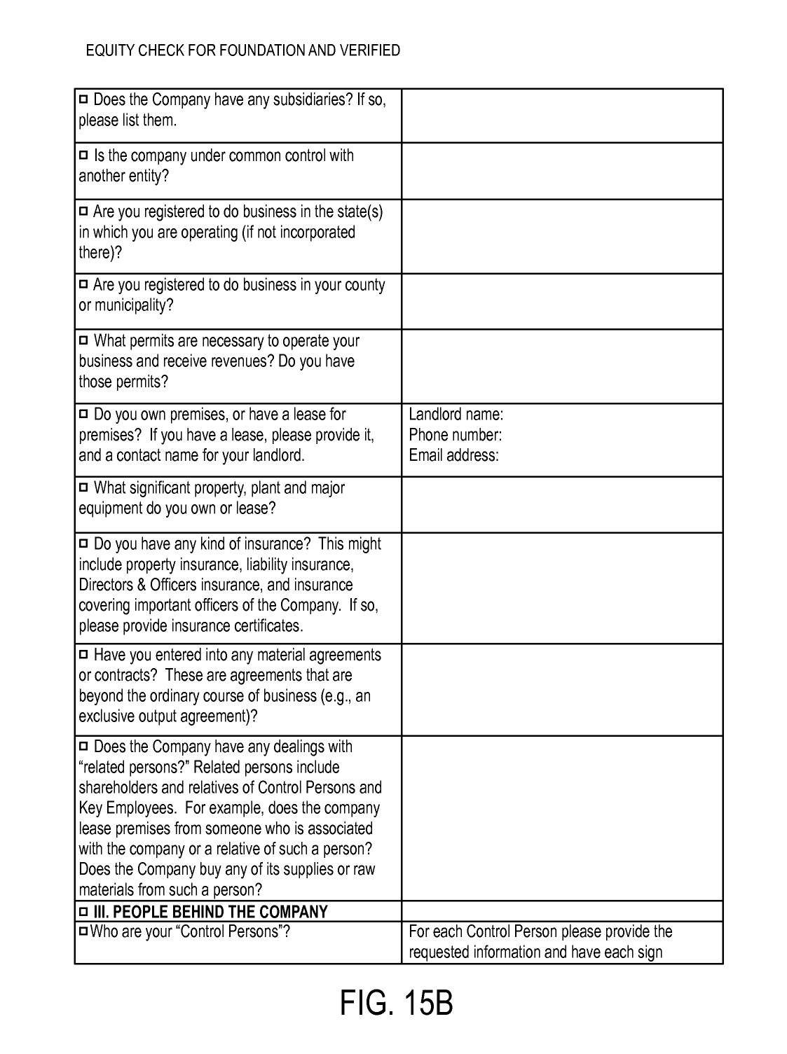

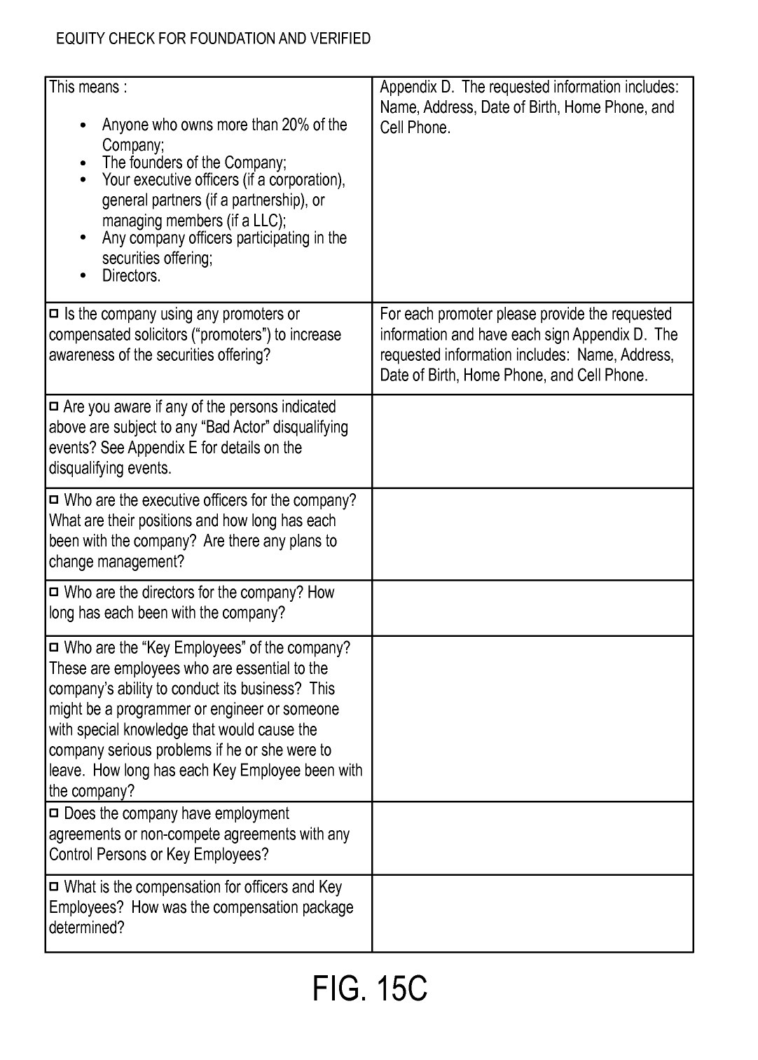

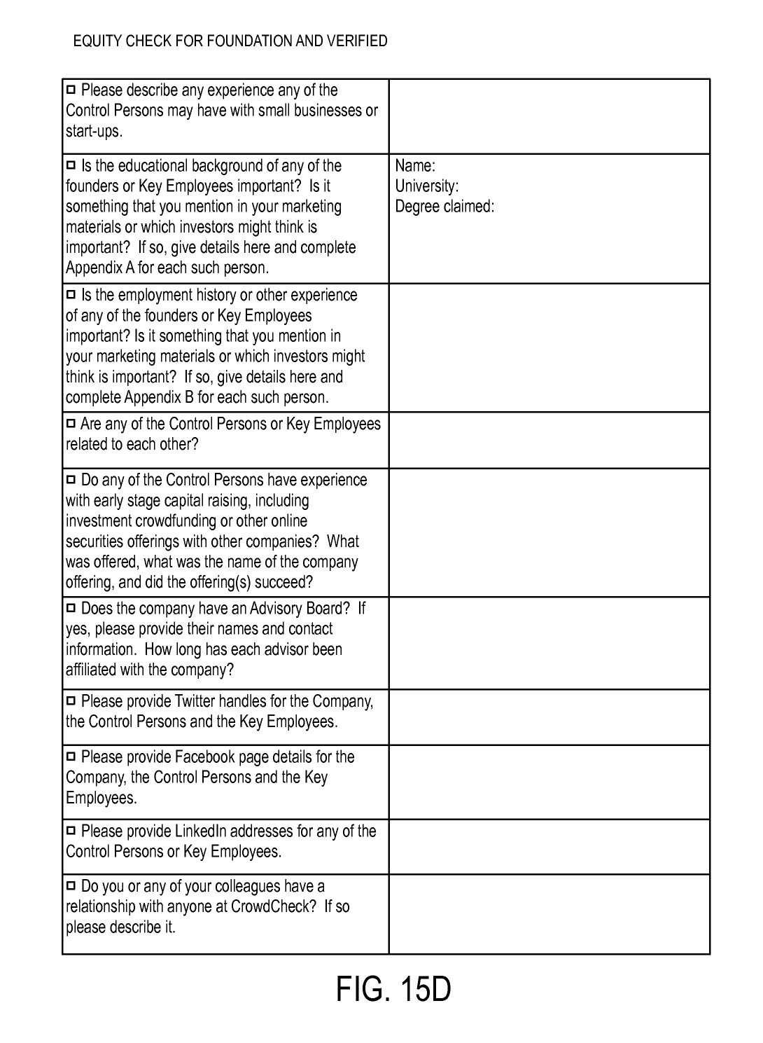

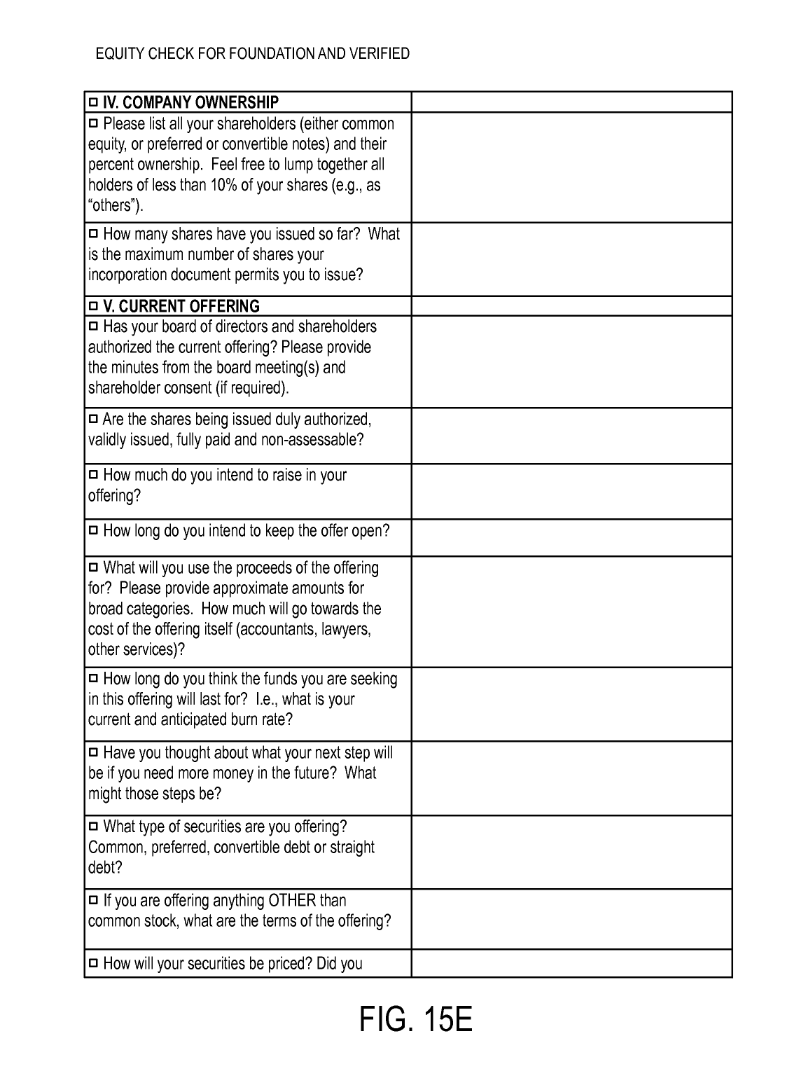

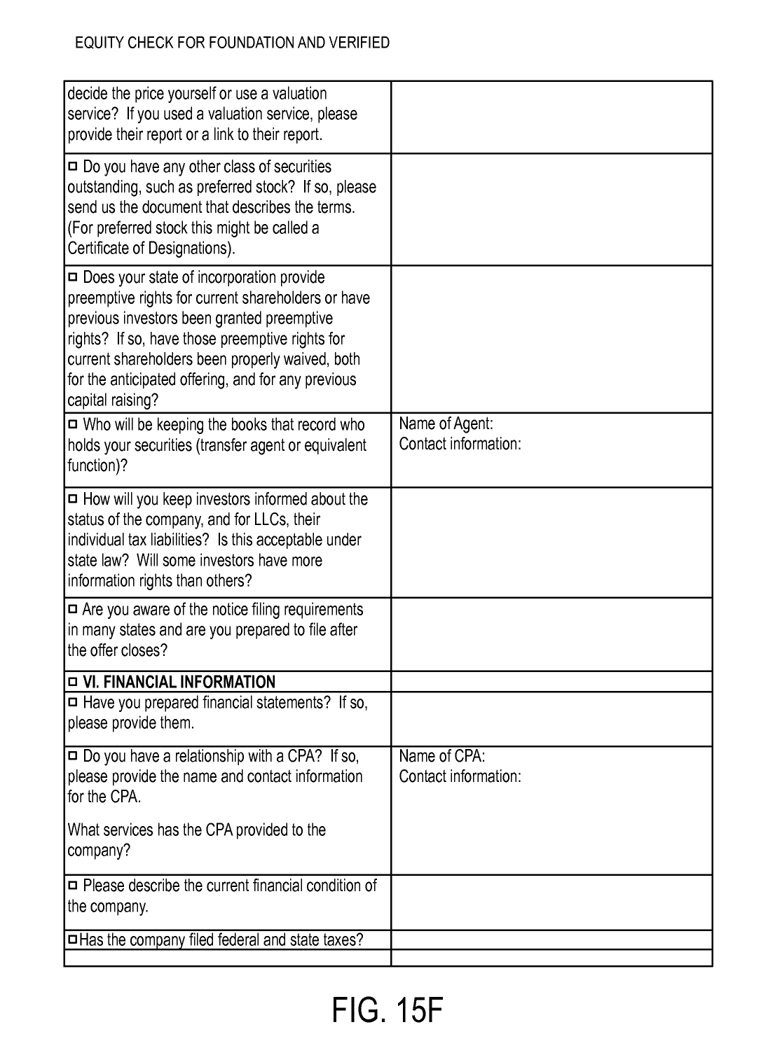

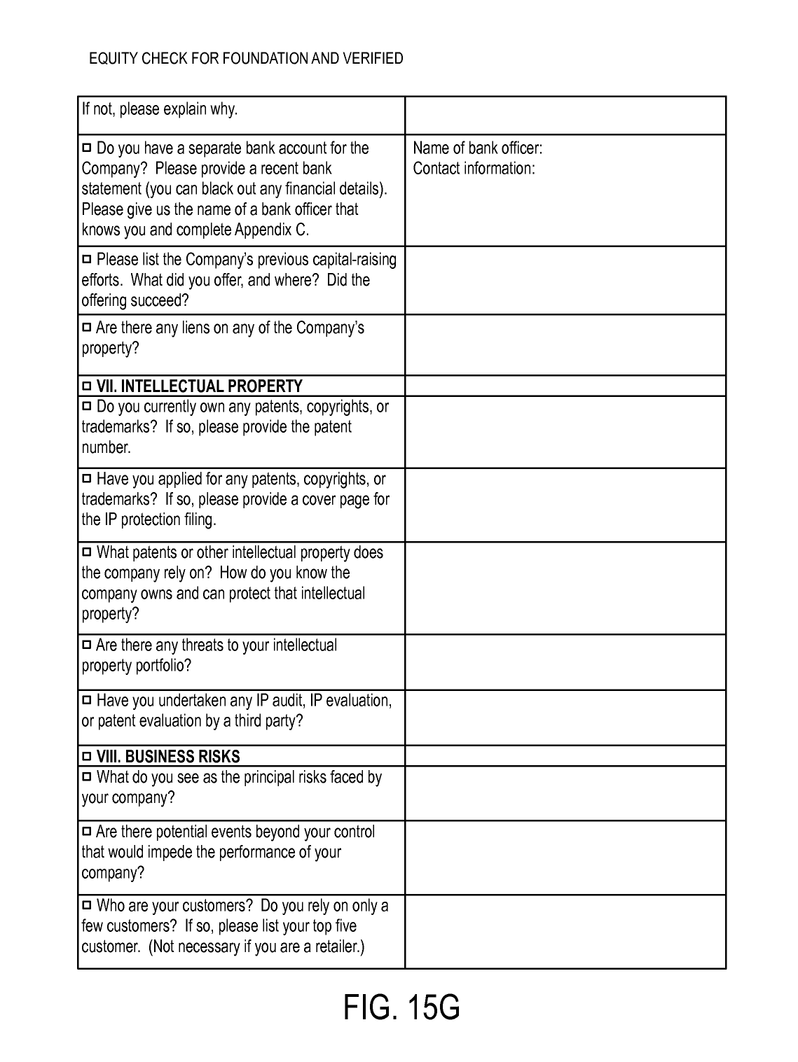

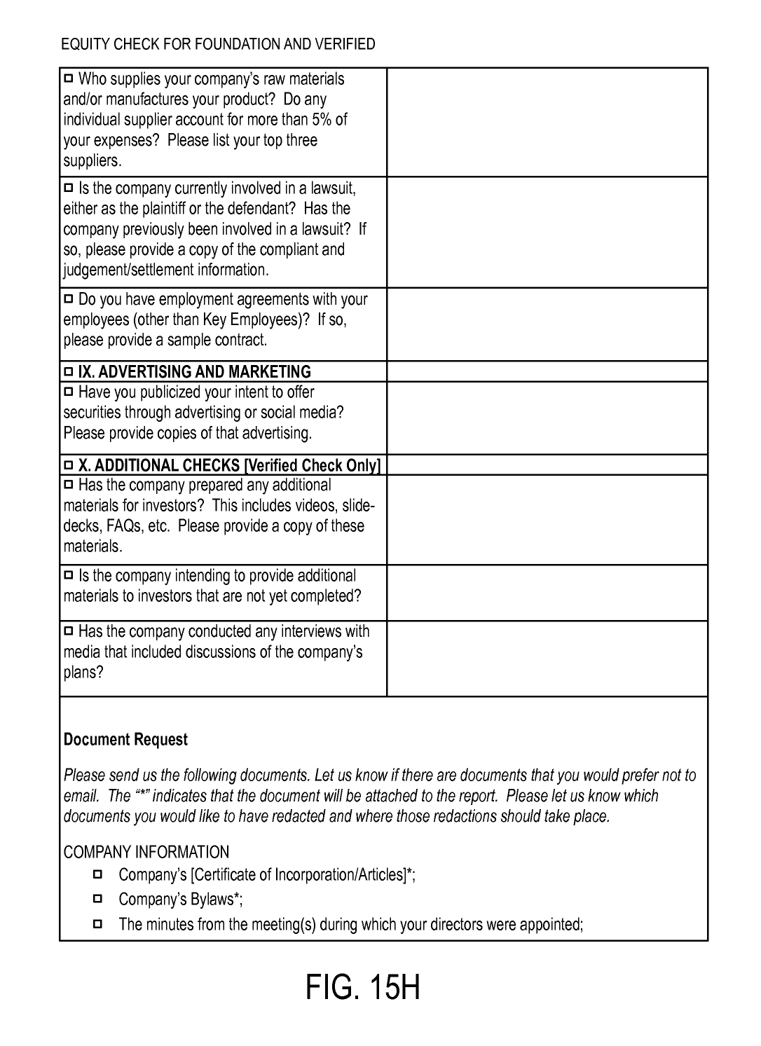

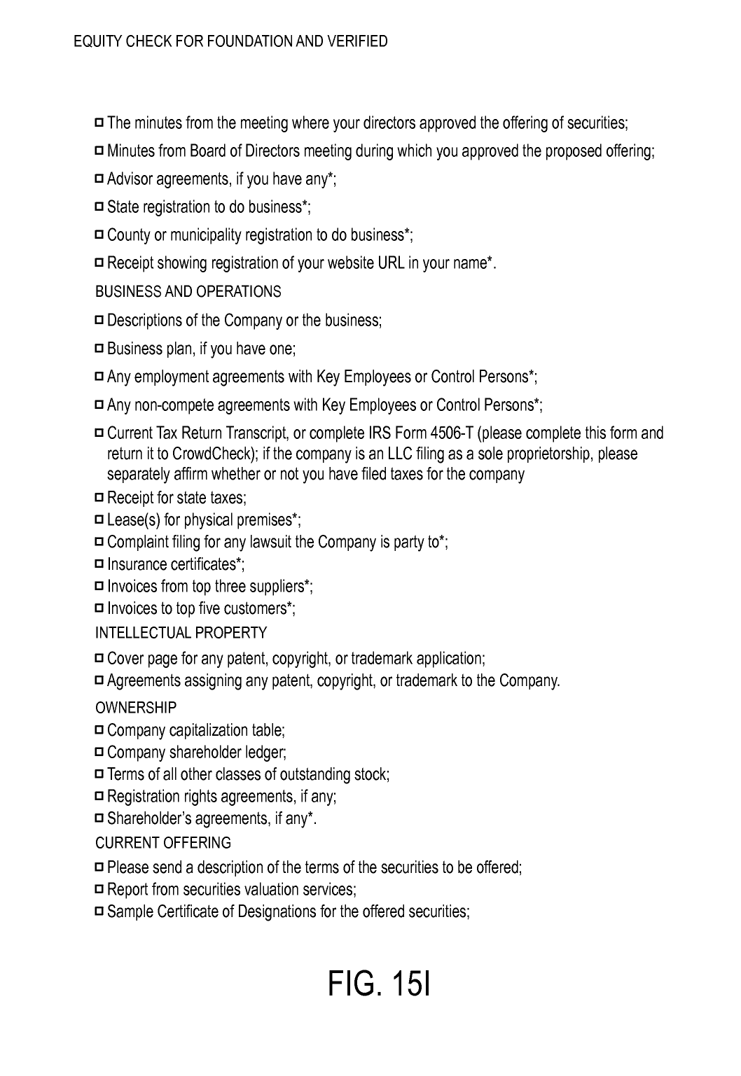

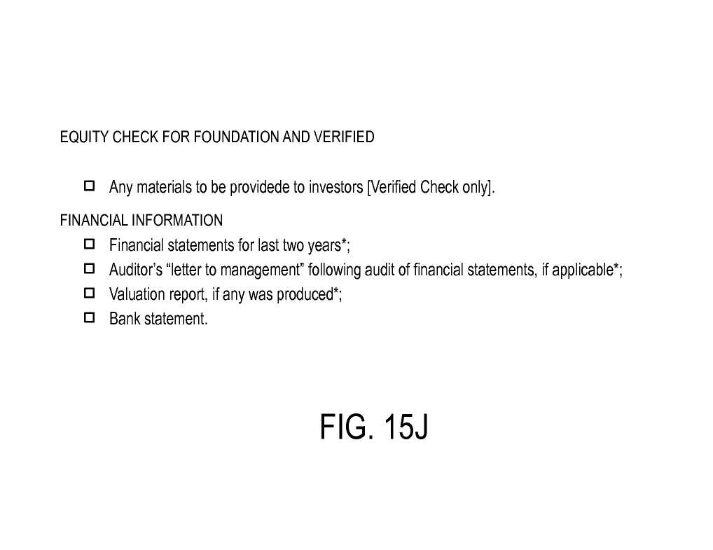

FIGS. 15A-15J depict exemplary information, document request and release forms for receiving information about a company. Any of the information depicted on or described by FIGS. 15A-15J may be received and/or stored as discussed herein. For example, any or all of the information depicted on or described by FIGS. 15A-15J may be collected as initial contact and identifying information, core information, and/or additional information.

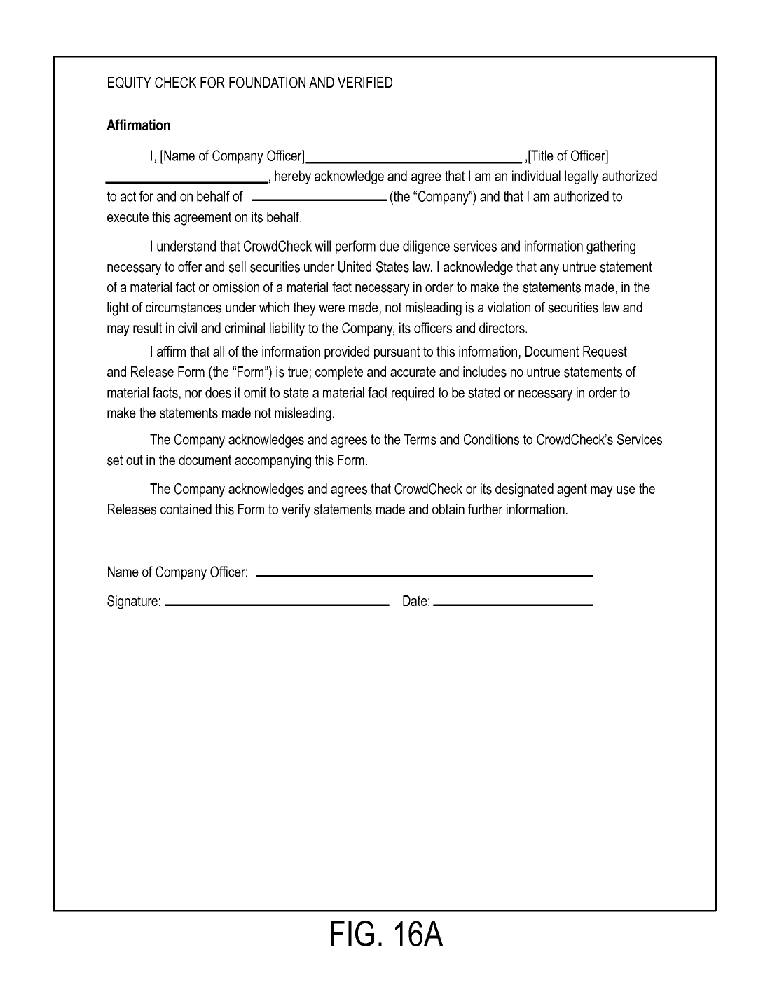

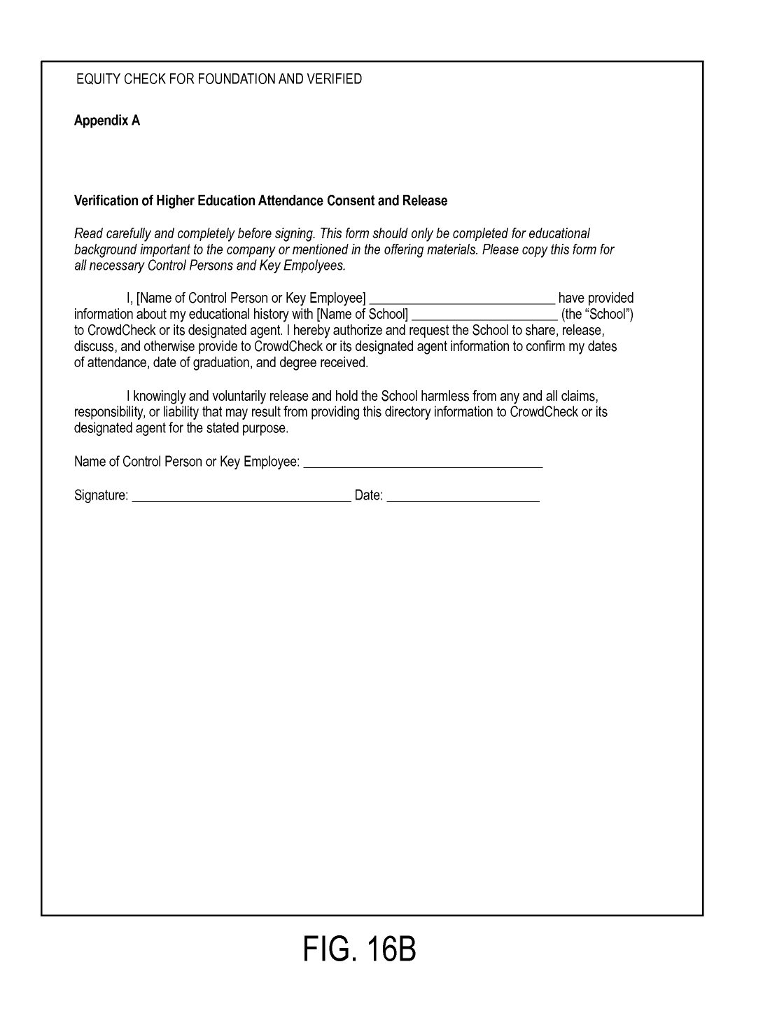

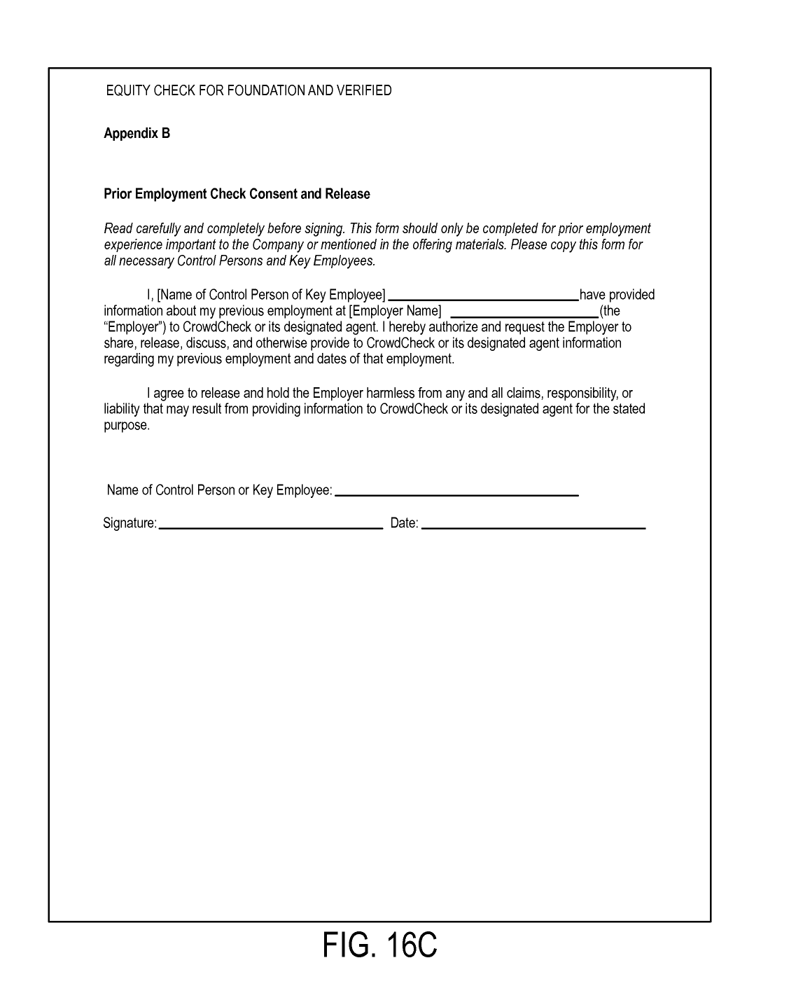

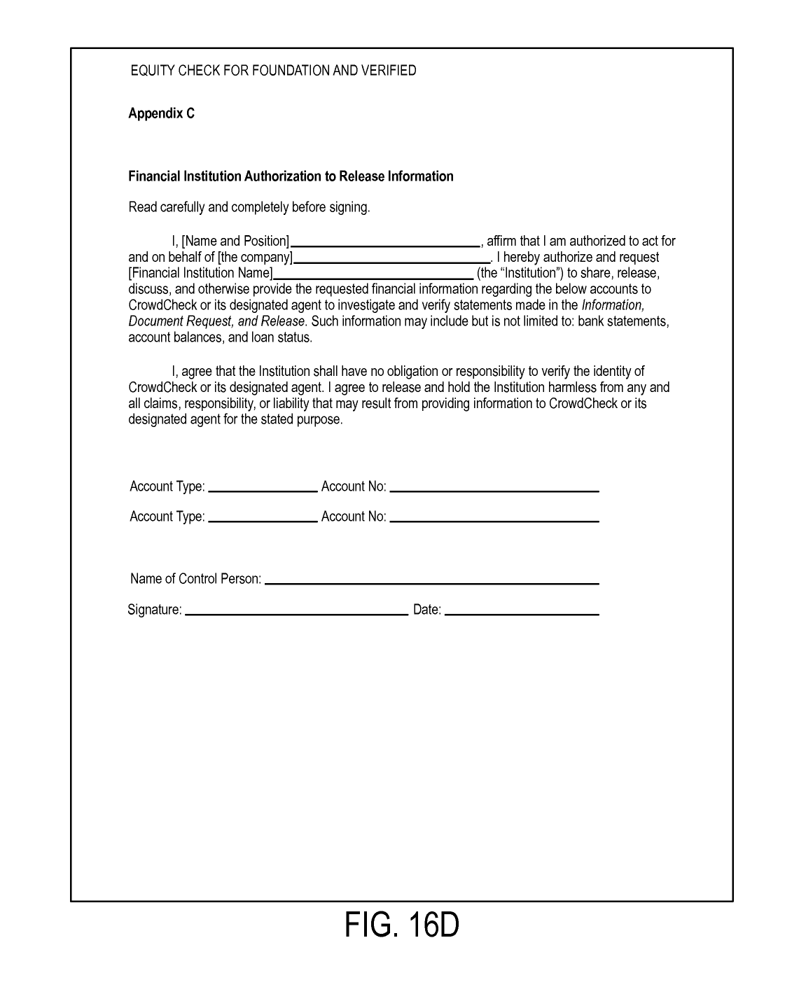

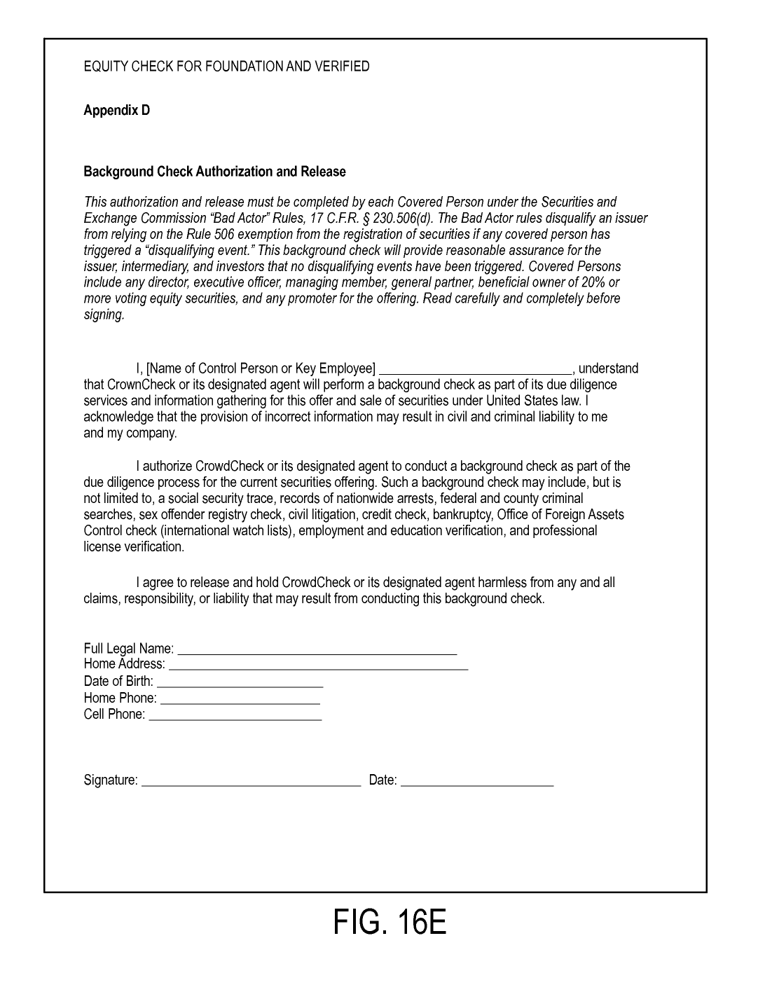

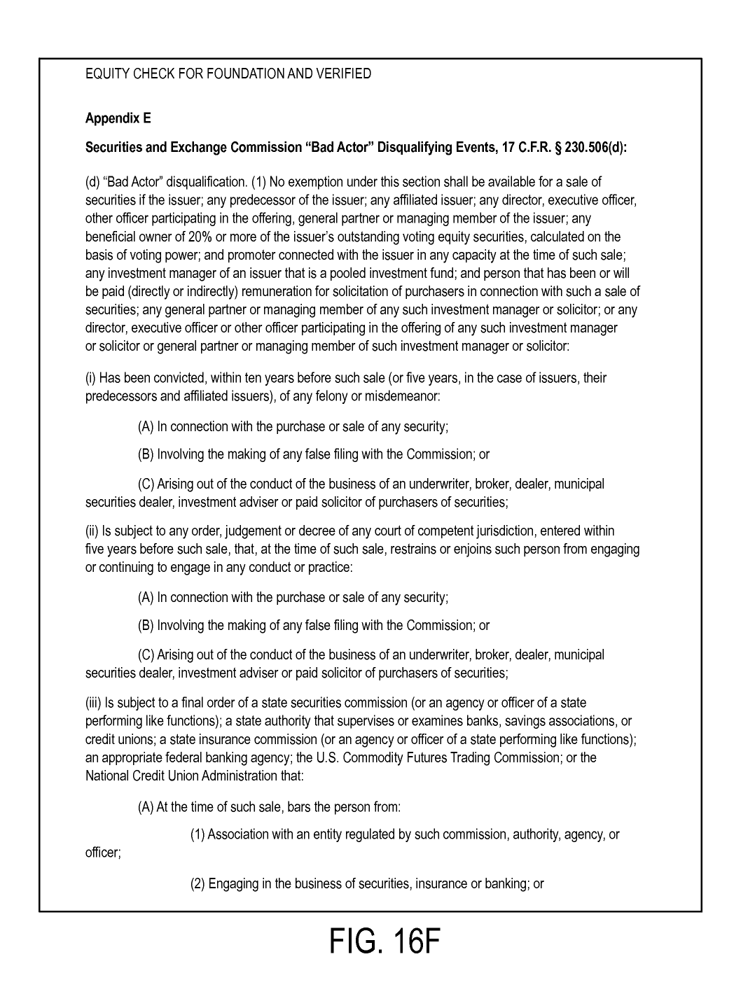

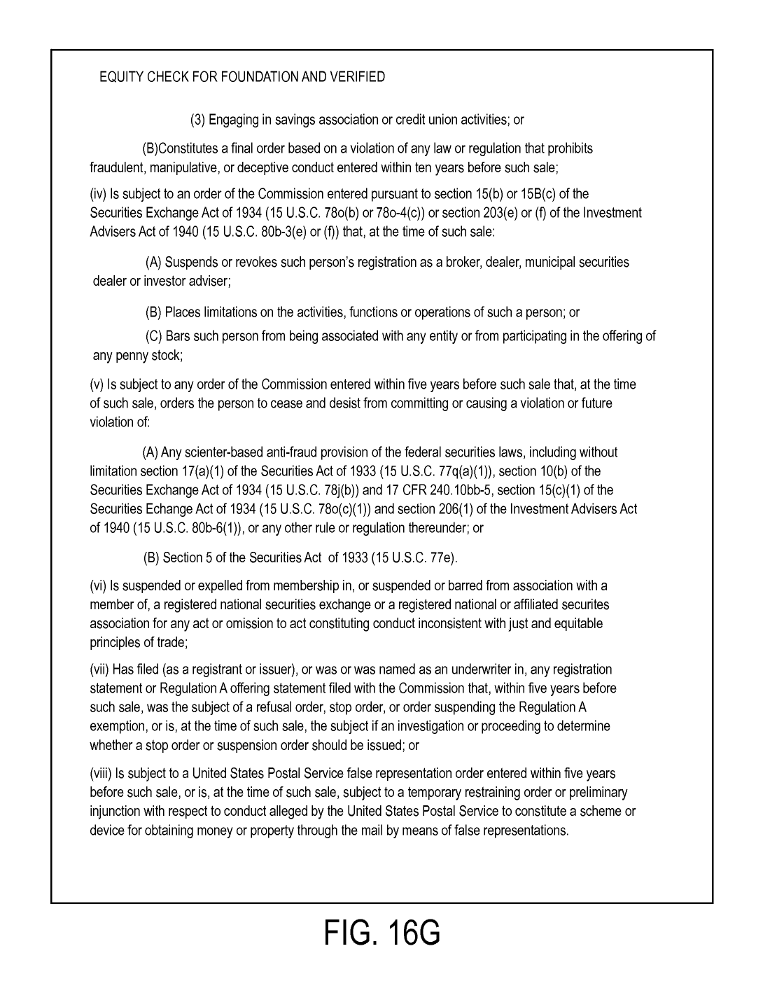

FIGS. 16A-16G depict exemplary affirmations, verifications, and release forms for receiving information about a company. Any of the information depicted on or described by FIGS. 16A-16G may be received and/or stored as discussed herein. For example, any or all of the information depicted on or described by FIGS. 16A-16G may be collected as initial contact and identifying information, core information, and/or additional information. Further, the affirmations, verifications, and/or releases depicteds in FIGS. 16A-16G may be required in order to satisfy the criteria of the provider for issuing a report.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible and/or non-transitory storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

It should be noted that while this particular representation of the disclosed subject matter portrays a report integrated into a platform's website the disclosed subject matter is not limited to such use and can also include other mediums, including but not limited to other parties' websites, television, mobile devices, and print.

Although example diagrams to implement elements of the disclosed subject matter have been provided, one skilled in the art, using this disclosure, could develop additional hardware, software, or processes to practice the disclosed subject matter and each is intended to be included herein.

In addition to the above described embodiments, those skilled in the art will appreciate that this disclosure has application in a variety of arts and situations and this disclosure is intended to include the same.

What is claimed is:

1. A method for performing due diligence disclosure services, the method comprising:
receiving initial contact and identifying information from an entity about a company seeking investment;
transmitting core information derived from the initial contact and identifying information to a provider;
receiving results of due diligence on the company performed by the provider using the core information;
preparing a report based on results of performing due diligence; and
providing the report to a computing device.

2. The method of claim 1 further comprising:
receiving a determination from the provider whether or not the received initial contact and identifying information is sufficient to proceed with the due diligence.

3. The method of claim 2 further comprising:
if the received initial contact and identifying information is determined not to be sufficient, issuing a request to the entity for more information.

4. The method of claim 2 further comprising:
if the received initial contact and identifying information is determined not to be sufficient, querying one or more third party databases for additional information until receiving a second determination from the provider that there is sufficient information to proceed with the due diligence.

5. The method of claim 1 wherein receiving results of due diligence on the company performed by the provider using the core information indicates that the company satisfies proprietary criteria of the provider.

6. The method of claim 1, wherein the report is free of technical defects and material defects.

7. The method of claim 1, wherein the entity is at least one of the company or an intermediary of the company.

8. The method of claim 1 further comprising:
generating a badge stamped with a date for a specific transaction; and
providing the badge to the computing device.

9. The method of claim 1, wherein the report comprises:
due diligence information about the company,
one or more links to one or more corresponding supporting documents that substantiate the due diligence information, and
a badge that provides a unique identifier for the particular transaction that the due diligence is being performed.

10. The method of claim 9, wherein the badge further comprises textual or visual cues that convey at least one of:
a time period during which the investment is taking place,
a type of due diligence check conducted,
an amount of money sought by the company, or
a platform serving as the intermediary.

11. The method of claim 9, wherein the one or more supporting documents comprises: a certificate of incorporation or articles of incorporation, bylaws of the company, a business plan, a tax receipt, an insurance certificate, a description of terms of securities to be offered, materials to be provided to investors, a financial statement, a bank statement, and a valuation report.

12. The method of claim 1, wherein the report is transmitted via a dashboard, an API, or email.

13. The method of claim 1, wherein transmitting the report to the computing device further comprises transmitting the report to at least one of the company, the intermediary, or a regulator.

14. The method of claim 1, wherein the report may be made publicly available.

15. The method of claim 1 further comprising:
requesting information or supporting documentation for performing a follow-up check on the company after the company raised money using the report; and
notifying an authority if an evaluation of the requested information or supporting documentation indicates a problem.

16. The method of claim 15, wherein the authority is at least one of the provider, a government, or a third party.

17. A system for performing due diligence disclosure services, the system comprising:
a memory; and
a processor in communication with the memory, wherein the processor is configured to:
receive initial contact and identifying information from an entity about a company seeking investment;
transmit core information derived from the initial contact and identifying information to a provider;
receive results of due diligence on the company performed by the provider using the core information;
prepare a report based on results of performing due diligence; and
provide the report to a computing device.

18. A computer readable storage medium for performing due diligence disclosure services, the computer readable storage medium comprising instructions that if executed enables a computing system to:
receive initial contact and identifying information from an entity about a company seeking investment;
transmit core information derived from the initial contact and identifying information to a provider;
receive results of due diligence on the company performed by the provider using the core information;
prepare a report based on results of performing due diligence; and
provide the report to a computing device.
